(19) United States
(12) Patent Application Publication
(10) Pub. No.: US 2024/0213724 A1
(43) Pub. Date: Jun. 27, 2024

(54) ELECTRICAL CONNECTOR

(71) Applicant: Apple Inc., Cupertino, CA (US)

(72) Inventors: Joshua A. Mendoza, Lancaster, CA (US); Daniel C. Wagman, Scotts Valley, CA (US); Ibuki Kamei, Santa Clara, CA (US); Muhammad F. Hossain, Sunnyvale, CA (US); Samuel G. Smith, San Francisco, CA (US); Christopher S. Graham, San Francisco, CA (US)

(21) Appl. No.: 18/596,496

(22) Filed: Mar. 5, 2024

Related U.S. Application Data
(63) Continuation of application No. PCT/US2022/076406, filed on Sep. 14, 2022.
(60) Provisional application No. 63/261,254, filed on Sep. 15, 2021.

(51) Int. Cl. H01R 13/73; H01R 12/72; H01R 13/405; H01R 13/70

(52) U.S. Cl. CPC H01R 13/73; H01R 12/72; H01R 13/405; H01R 13/70

(57) ABSTRACT

An electronic device can include an enclosure and a receptacle connector coupled to the enclosure. The receptacle connector can include a housing defining an aperture and an internal volume. In some examples, the housing is configured to receive a plug connector of a support within the internal volume. The receptacle connector can include one or more electrical contacts at least partially disposed within the internal volume and contacting one or more correlating electrical contacts on the plug connector. In some examples, the plug connector and the receptacle connector can define respective convex surfaces and respective concave surfaces such that a cross-sectional shape of the plug connector and/or the receptacle connector has a curved longitudinal axis.

### CROSS-REFERENCE TO RELATED APPLICATION(S)

This application is a continuation of International Application No. PCT/US2022/076406, filed 14 Sep. 2022, and entitled “ELECTRICAL CONNECTOR,” which claims priority to U.S. Provisional Patent Application No. 63/261,254, filed 15 Sep. 2021, and entitled “ELECTRICAL CONNECTOR,” the disclosures of which are hereby incorporated by reference in their entireties.

### FIELD

The described embodiments relate generally to interconnecting electronic devices. More particularly, the present embodiments relate to plug connectors and receptacle connectors for electronic devices.

### BACKGROUND

Electronic devices are increasingly being designed with device portability in mind, for example, to allow users to use these devices in a wide variety of situations and environments. Indeed, power sources, such as lithium batteries, can power an electronic device for a substantial duration of time and in a variety of indoor and outdoor environments. Components within an electronic device, such as, a processor, memory, antennas, and other components, can be disposed within a portable housing to protect the components from damage or failure induced by an environment external to the housing. Improvements and advances to portable electronic devices can be desirable to provide additional functionality in a variety of situations and environments.

### SUMMARY

According to some aspects of the present disclosure, a head mountable display (HMD) can include a housing, a display connected to the housing, and a receptacle connector disposed in the housing. The receptacle connector can include a receptacle housing and an electrical contact. The receptacle housing can define an aperture and an internal volume. The receptacle housing can be configured to receive a portion of a support of the HMD within the internal volume. The electrical contact can be at least partially disposed within the internal volume. The electrical contact can be configured to electrically couple the receptacle connector and the support. An engagement feature can be disposed within an aperture formed within a side wall of the receptacle housing, the engagement feature extending into the internal volume from the side wall and being movable relative to the side wall. In one example, a mount can be connected to the receptacle housing and the engagement feature can be pivotably attached to the mount.

In some examples, the aperture can define a cross-sectional shape having a curving longitudinal axis. In examples, the HMD can further include a datum rail disposed on a side wall of the receptacle housing. The datum rail can extend into the internal volume. In some examples, the receptacle connector can include a spring biasing the engagement feature to extend into the internal volume. The engagement feature can be configured to interlock with the portion of the support. In some examples, the HMD can further include a mount connected to the receptacle housing, wherein the engagement feature is pivotably attached to the mount.

In some examples, the receptacle housing of the HMD can be made of an electrically insulating material. The electrical contact can be disposed within a side wall of the receptacle housing. The receptacle connector can include a cover member. The receptacle connector can include an intermediate layer disposed between the receptacle housing and the cover member. The intermediate layer can electrically isolate the set of electrical contacts from the cover member. In examples, the electrical contact can be a first electrical contact of a first set of electrical contacts. The receptacle connector can further include a second set of electrical contacts at least partially disposed within the internal volume. The first set of electrical contacts can be disposed on a first side of the internal volume. The second set of electrical contacts can be disposed on a second side of the internal volume.

According to some examples, a plug connector for engaging with a head mountable display can include a body, an electrical contact, a printed circuit board (PCB), and a processor. The body can include a convex surface defining a first surface of the body, a concave surface defining a second surface of the body opposite the first surface, a third surface of the body extending between the first surface and the second surface, and a fourth surface extending between the first surface and the second surface opposite the third surface. The electrical contact can be disposed on the concave surface or the convex surface and a polymer can be disposed over the body around the electrical contact. Additionally, a side engagement slot can be defined by the third surface extending from the first surface to the second surface. The PCB can be electrically coupled to the electrical contact. The processor can be disposed on the PCB.

In some examples, the body can also form a channel at a third surface of the body. In examples, the plug connector can include a button module having a switch housing, a switch structure, a button, and an engagement member. The switch structure can be at least partially disposed within the switch housing. The button can be coupled to the switch structure. The engagement member can be coupled to the switch structure and configured to translate relative to the switch housing. The printed circuit board can define a cutout and the button module can be at least partially disposed within the cutout. The electrical contact can be a first electrical contact disposed on the concave surface. The plug connector can also include a second electrical contact disposed on the convex surface. The body can include a metal portion. The convex surface can be at least partially defined by a polymer coupled to the metal portion. The concave surface can be at least partially defined by the polymer coupled to the metal portion. The electrical contact can be at least partially disposed within the polymer.

In examples, the plug connector can include a button module having a rotating member, a button, and a sliding member. The rotating member can define a slot. The button can define a protrusion at least partially disposed within the slot. Translation of the button can cause the rotating member to rotate about an axis. Rotation of the rotating member can displace the sliding member from a first location to a second location. In other examples, the plug connector can include a button module having a sliding member and a button contacting the sliding member. Pressing the button can cause the sliding member to translate relative to the button. The button can translate along a first axis. The sliding member can translate along a second axis substantially perpendicular to the first axis.

According to some aspects of the disclosure, a support for a head-mounted display (HMD) is disclosed. The support can include an enclosure and a plug connector. The enclosure can have a proximal end. The plug connector can be attached to the proximal end and configured to be electrically coupled to a display portion of the HMD. The plug connector can include a body, an electrical contact, a printed circuit board (PCB), and a speaker.

In some examples, the enclosure can define a cross-sectional shape having a curving longitudinal axis. In examples, the plug connector also includes an electrical wire coupled to the PCB and extending within the enclosure toward the distal end. The electrical contact can be one of multiple electrical contacts disposed on two or more surfaces defined by the body. In some examples, the support includes a receptacle connector electrically coupled to the plug connector. The receptacle connector can be disposed on the enclosure between the proximal end and the distal end.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective side view of a portable electronic device.

FIG. 1B shows a perspective side view of the portable electronic device.

FIG. 2A shows a side view of a support.

FIG. 2B shows another side view of the support.

FIG. 2C shows a perspective detail view of a proximal end of the support.

FIG. 2D shows a perspective detail view of the proximal end of the support.

FIG. 3A shows a perspective side view of a plug connector.

FIG. 3B shows a cross-sectional view of the plug connector.

FIG. 3C shows a cross-sectional view of a plug connector.

FIG. 3D shows an exploded view of the plug connector.

FIG. 3E shows an exploded view of the button module.

FIG. 3F shows an exploded view of a button module.

FIG. 3G shows a perspective side view of the button module and a printed circuit board.

FIG. 3H shows a side view of a grounding member of the button module.

FIG. 3I shows a perspective side view of a plug connector.

FIG. 3J shows a top view of a plug connector.

FIG. 4 shows a side view of a plug connector.

FIG. 5A shows a side view of a proximal end of a support.

FIG. 5B shows a side view of a proximal end of a support.

FIG. 5C shows a side view of a proximal end of a support.

FIG. 5D shows a side view of a proximal end of a support.

FIG. 5E shows another side view of the proximal end of the support.

FIG. 5F shows a side view of a proximal end of a support.

FIG. 5G shows another side view of the proximal end of the support.

FIG. 6A shows a perspective front view of a receptacle connector.

FIG. 6B shows a perspective rear view of the receptacle connector.

FIG. 6C shows an exploded view of the receptacle connector.

FIG. 7A shows a rear view of a receptacle connector disposed within a display portion of a head-mounted display.

FIG. 7B shows a perspective detailed view of the receptacle disposed within the display portion.

FIG. 7C shows a cross-sectional view of the display portion and a support.

FIG. 7D shows a cross-sectional view of the display portion and the support in a first configuration.

FIG. 7E shows a cross-sectional view of the display portion and the support in a second configuration.

FIG. 7F shows a partially exploded view of an interlock and an enclosure.

FIG. 7G shows a detail view of an interlock on an enclosure.

FIG. 8A shows a side view of a support including a button module.

FIG. 8B shows a partial cross-sectional side view of the support including the button module.

FIG. 8C shows a partial cross-sectional side view of the support including the button module.

FIG. 8D shows a cross-sectional view of a display portion and the support.

FIG. 8E shows a cross-sectional view of the display portion and the support in a first configuration.

FIG. 8F shows a cross-sectional view of the display portion and the support in a second configuration.

FIG. 9A shows a partial cross-sectional side view of a support including a button module.

FIG. 9B shows a partial cross-sectional side view of the support including the button module.

FIG. 9C shows a cross-sectional view of a display portion and the support.

FIG. 9D shows a cross-sectional view of the display portion and the support in a first configuration.

FIG. 9E shows a cross-sectional view of the display portion and the support in a second configuration.

FIG. 10A shows a partial cross-sectional side view of a support including a button module.

FIG. 10B shows a partial cross-sectional side view of the support including the button module.

FIG. 11A shows a side view of a proximal end of a support.

FIG. 11B shows a receptacle connector including retention clips in a first orientation.

FIG. 11C shows the receptacle connector including retention clips in a second orientation.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Portable electronic devices, such as smart phones, laptops, tablet computing devices, smart watches, head-mounted displays (HMD), and headphones, have become commonplace for persons undertaking daily activities (travel, communication, education, entertainment, employment, etc.). Indeed, portable electronic devices can provide assistance in completing daily tasks and errands, such as, watching an instructional video or monitoring progress during and after an exercise routine. However, some electronic devices necessarily require a temporary or permanent cabled connection to operate (e.g., charging the device, providing electrical power to an electronic component, interconnecting a peripheral input or output device, etc.).

Regarding HMDs, the temporary or permanent cabled connection can be coupled to a display portion of the HMD. For example, the HMD can include one or more battery packs or electrical power sources that require regular charging to operate the HMD for an extended period of time. However, a cabled connection to the display portion can inhibit (i.e., snag on the user or objects around the user while in use) or otherwise limit a user from operating the HMD while charging.

In some examples of the present disclosure, a display portion of a HMD can additionally, or alternatively, receive electrical power or control signals through a support electrically coupled to the display portion. For example, the support can include a plug connector which is coupled (structurally and electrically) within a receptacle connector of the display portion. While coupled, the support can define an electrical path which enables electrical power and/or control signals to pass between the display portion and another electronic device (e.g., an electrical power source, such as, a battery pack) electrically coupled to the support. For example, the support can include a receptacle connector configured to electrically couple an electronic device to the support.

One aspect of the present disclosure relates to an electronic device, (e.g., an HMD) including an enclosure and a receptacle connector coupled to the enclosure. The receptacle connector can include a housing defining an aperture and an internal volume. In some examples, the housing is configured to receive a plug connector of a support within the internal volume. The receptacle connector can include one or more electrical contacts at least partially disposed within the internal volume and contacting one or more correlating electrical contacts on the plug connector. In some examples, the plug connector and the receptacle connector can define respective convex surfaces and respective concave surfaces such that a cross-sectional shape of the plug connector and/or the receptacle connector has a curved longitudinal axis L. In other examples, the cross sectional shape of the plug connector and/or the receptacle connector can have a substantially straight longitudinal axis L. While the electronic device is described as an HMD, the electronic device can alternatively, or additionally, include a smart phone, laptop, tablet computing device, smart watch, headphones, or any other electronic device.

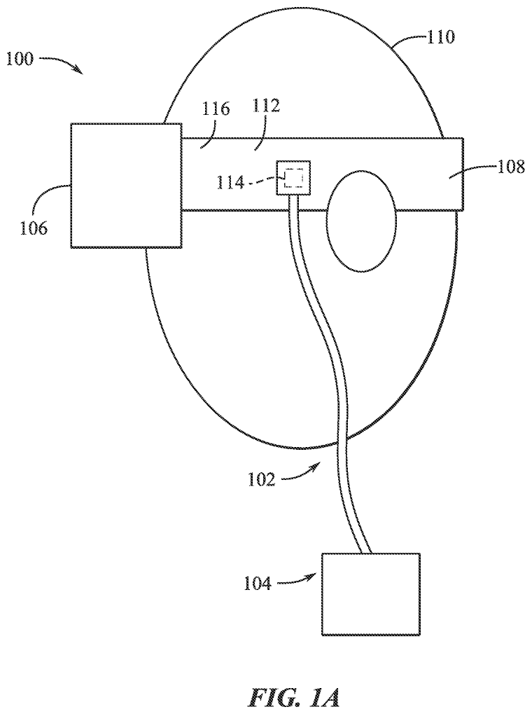

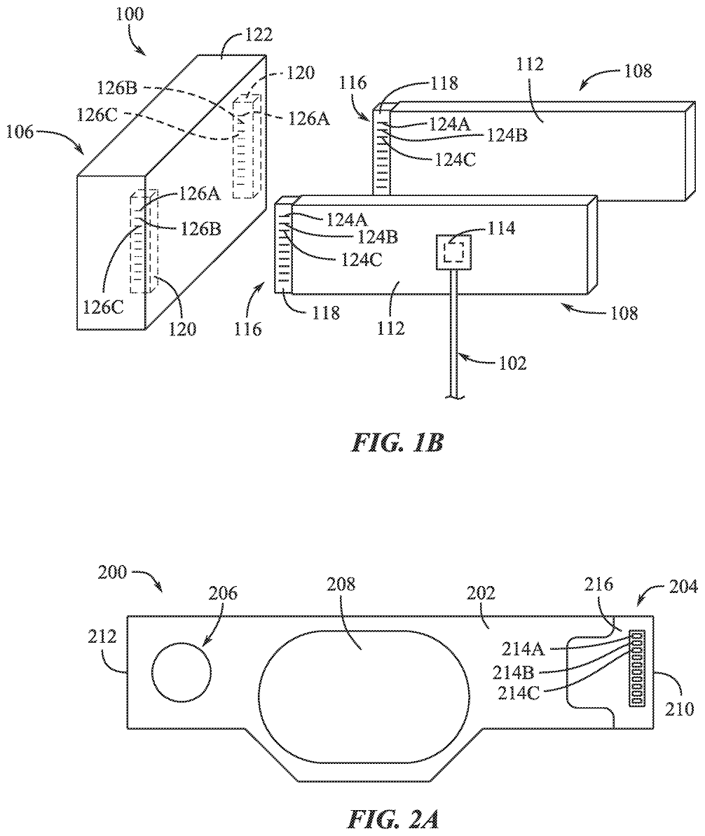

These and other embodiments are discussed below with reference to FIGS. 1A-11C. However, those skilled in the art will readily appreciate that the detailed description given herein with respect to these Figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1A shows a first electronic device 100, a cable assembly 102, and a second electronic device 104. In some examples, the first electronic device 100 can be a head-mounted display (HMD) including a display portion 106 and one or more supports 108.

While the first electronic device 100 is illustrated as a head-mounted display (HMD), the first electronic device 100 can be a tablet computing device, smart phone, smart watch, or any other electronic device in other examples. The display portion 106 can output visual content viewable by a user of the electronic device 100. For example, the display portion 106 can include a light-emitting diode (LED) display, an organic light-emitting diode (OLED) display, a liquid-crystal display (LCD) display, a micro-LED display, or the like. In some examples, the display portion 106 can include any form of display now known in the art, or as may be developed in the future.

The one or more supports 108 can retain the electronic device 100 relative to a head 110 of the user. In some examples, the first electronic device 100 can include a second support (see FIG. 1B) that is coupled to the display portion 106 and configured to be positioned on the other side of the user's head 110. In some examples, the support 108 can be a band or can include a band portion coupled to the enclosure and can be configured to wrap around or otherwise encircle a portion of the user's head 110 and couple to the display portion 106 at two or more locations. In some examples, the band or band portion can be made of an elastomer material which can flex or stretch and thereafter return to an initial state.

The one or more supports 108 can each include a housing or an enclosure 112 formed from a polymer, metal, ceramic, or combination thereof. In some examples, the enclosure 112 can form a channel or cavity extending between a receptacle connector 114 of the support 108 to the display portion 106. The support 108 can be electrically coupled to the display portion 106 such that electrical signals and/or electrical power received at the receptacle connector 114 can be provided to the display portion 106 or other electronic components of the first electronic device 100. For example, one or more electronic components (e.g., printed circuit boards, processors, electrical wires, digital logic circuitry, digital processing circuitry, etc.) can be positioned within the cavity formed within the enclosure 112 and extend between the receptacle connector 114 and the display portion 106 to form an electrical path between the receptacle connector 114 and the display portion 106. In some examples, the one or more supports 108 can each be coupled to the display portion 106. For example, each support 108 can be welded, adhered, fastened, crimped, clipped, or otherwise retained within a receptacle connector 120 (see FIG. 1B) of the display portion 106. In some examples, at least a portion of a proximal end (i.e., proximal end 116) of the support 108 can be electrically conductive or include a plug connector 118 that enables electrical power and/or electrical signals received by the receptacle connector 114 of the support 108 to be transferred to the display portion 106.

In some examples, the support 108 can be a band or can include a band portion coupled to the enclosure 112 and can be configured to wrap around or otherwise encircle a portion of the user's head 110 and couple to the display portion 106 at two or more locations. In some examples, the band or band portion can be made of an elastomer material which can flex or stretch and thereafter return to an initial state. Examples of receptacle connectors 114 on a support 108 for an HMD are disclosed in Provisional Patent Application No. 63/261,257, filed 15 Sep. 2021, and entitled “Electrical Connector” and Provisional Patent Application No. 63/261,254, filed 15 Sep. 2021, and entitled “Electrical Connector,” the disclosures of which are incorporated herein in their entireties, by reference.

As illustrated in FIGS. 1A and 1B, each of the supports 108 can include a plug connector 118 disposed at the respective proximal ends 116 of the supports 108. The plug connector 118 can be coupled (e.g., electrically and structurally) to the display portion 106 by disposing the proximal end 116 of the support 108 into a receptacle connector 120 coupled to a housing 122 of the display portion 106. The receptacle connector 120 can be positioned on or within the housing 122 of the display portion 106. In some examples, the receptacle connector 120 of the display portion 106 can be in electrical communication with the receptacle connector 114 of the support 108. That is, the cable assembly 102 can operably couple to the receptacle connector 114 of the support 108 rather than directly coupling to the display portion 106 to electrical power and/or electrical signals can be transferred between the receptacle connector 114 of the support 108 and the receptacle connector 120 of the display portion 106.

Some head-mounted displays (HMDs) utilize a re-chargeable power source (e.g., a battery) affixed to the head-mounted display to provide electrical power to the electronic components (e.g., processors, displays, speakers, etc.). The size or capacity of the re-chargeable power source can be limited by the desired size, shape, and weight of the head-mounted display. After the re-chargeable power source has been substantially depleted of electrical power, the user may be required to discontinue use of the head-mounted display to allow re-charging of the electrical power source.

In some aspects of the present disclosure, rather than solely relying on a power source disposed within the head-mounted display (e.g., the first electronic device 100), at least one power source (e.g., the second electronic device 104) can be additionally, or alternatively, electrically coupled to the head-mounted display by a cabled connection (e.g., the cable assembly 102) which electrically couples to the support 108 via the receptacle connector 114. Electrically coupling the power source (e.g., the second electronic device 104) to the display portion 106 via the support 108 and the receptacle connector 120 (e.g., through the receptacle connector 114 and the plug connector 118) can be advantageous. For example, electrical power and/or electrical signals can be provided to the first electronic device 100 while the second electronic device 104 is disposed within a case, pocket, pouch, or otherwise retained by the user. Relocating the electrical power source away from the head-mounted display can accommodate a larger electrical power source than can be directly disposed on the head-mounted display which can provide for extended use of the electronic device 100. Supplying electrical power and signals to the display portion 106 through the support 108 (e.g., through the receptacle connector 114, the plug connector 118, and the receptacle connector 120) can be beneficial in at least partially limiting user contact with the cable assembly 102 by positioning the cable assembly 102 at the side of the user rather than dangling or hanging the cable assembly in front of the user near the head-mounted display.

The plug connector 118 can include one or more electrical contacts 124A, 124B, 124C which electrically couple to respective electrical contacts 126A, 126B, 126C disposed within the receptacle connector 120 while the plug connector 118 is disposed within the receptacle connector 120. The one or more electrical contacts 124A, 124B, 124C and the correlating one or more electrical contacts 126A, 126B, 126C can provide electrical signals, electrical power, a grounding path, another electrical communication, or a combination thereof between the support 108 and the display portion 106.

Electrically coupling a power source (e.g., the second electronic device 104) to the receptacle connector 114 within the support 108, as opposed to disposing the power source directly on the display portion 106 can also enable a reduction in the weight and/or a size of the display portion 106. A reduction in the weight and/or size of the display portion 106 can render the first electronic device 100 more comfortable during use, more convenient to transport, and more convenient to store. While the receptacle connector 120 and the plug connector 118 are shown in FIGS. 1A and 1B as having a cubic shape or square cross-section, the receptacle connector 120 and the plug connector 118 can define other shapes and cross-sections in other examples. For example, the cross-section of the receptacle connector 120 and the plug connector 118 can be elongated and/or curved such that the support 108 can only be inserted into the receptacle connector 120 of the display portion 106 in a single orientation.

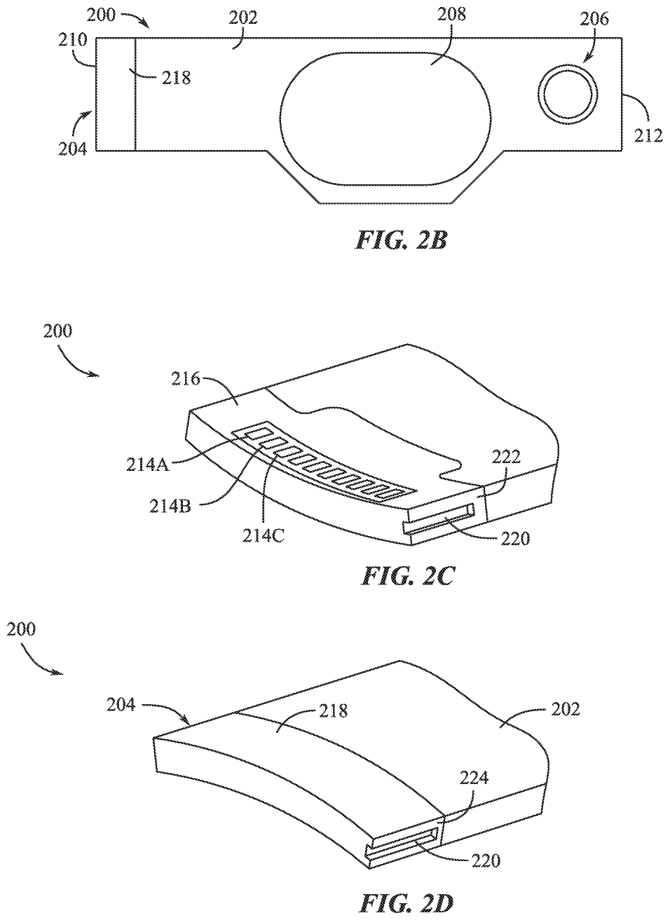

Any number or variety of components in any of the configurations described herein can be included in the electronic device (e.g., HMD). The components can include any combination of the features described herein and can be arranged in any of the various configurations described herein. The structure and arrangement of components of an electronic device having an support and a display portion with structures described herein as well as the concepts regarding various sub-components, can apply not only to the specific examples discussed herein, but to any number of examples in any combination. Examples of supports for an HMD are described below, with reference to FIGS. 2A-2D.

FIGS. 2A and 2B show side views of a support 200 of an HMD including an enclosure 202 and a plug connector 204. In some examples, the support 200 can include a receptacle connector 206 and an electronic component 208. The receptacle connector 206 can be substantially similar to, and can include some or all of, the features of the receptacle connector 114. For example, the receptacle connector 206 can be disposed within or on the enclosure 202 and operably couple to a cable assembly (see FIG. 1A). The electronic component 208 can be any component or assembly that improves or provides additional functionality to the HMD. For example, the electronic component can be an electrical power source, a speaker, a microphone, a display, a user input region, a switch, a button, a processor, another type of electronic component, or a combination thereof.

In examples, the enclosure 202 can include a proximal end 210 and a distal end 212. While the support 200 is coupled to a display portion (e.g., the display portion 106), the proximal end 210 can be affixed to the display portion and the distal end 212 can be displaced from the display portion by the length of the support 200. In some examples, the receptacle connector 206 can be positioned or disposed near the distal end 212 of the support 200. The plug connector 204 can be molded, fastened, affixed, inserted, or otherwise coupled to the proximal end 210. For example, the enclosure 202 can be overmolded or co-molded onto a portion of the plug connector 204. In some examples, the enclosure 202 can form or define an internal volume which houses one or more electronic components (e.g., electrical wires, processors, sensors, audio components, printed circuit boards, other electronic components, or combinations thereof). For example, one or more electrical wires (not shown) can extend within the internal volume of the enclosure 202 between the plug connector 204 and the receptacle connector 206. The enclosure 202 can be machined, molded, stamped, extruded, or otherwise assembled from one or more discrete pieces. The enclosure 202 can be made out of a metal, ceramic, polymer, or any other material or combinations of materials.

The plug connector 204 can include one or more electrical contacts (e.g., electrical contacts 214A, 214B, 214C shown in FIG. 2A). For example, the one or more electrical contacts can be disposed on a first surface 216 of the plug connector 204. In some examples, a second surface 218 of the plug connector 204 can be devoid of electrical contacts (see FIG. 2B). However, in some examples, one or more electrical contacts can be additionally, or alternatively, disposed on the second surface 218. The one or more electrical contacts (e.g., electrical contacts 214A, 214B, 214C shown in FIG. 2A) can be substantially similar to, and can include some or all of, the features of the one or more electrical contacts 124A, 124B, 124C. For example, the electrical contacts can form at least a portion of an electrical path for electrical signals, electrical power, an electrical ground, another electrical communication, or a combination thereof to transfer between the support 200 and a display portion (e.g., display portion 106). Examples of supports including enclosures and plug connectors are described in greater detail herein with reference to FIGS. 2C-5G.

FIG. 2C and 2D show respective side perspective views of the proximal end 210 of the support 200. In some examples, the plug connector 204 can form or define the first surface 216 and the second surface 218. The first surface 216 can be a concave external surface or otherwise form a radius of curvature. The second surface 218 can be a convex external surface extending parallel or substantially parallel to the first surface 216. The one or more electrical contacts (e.g., electrical contacts 214A, 214B, 214C) can be disposed on the first surface 216 of the plug connector 204. In some examples, the second surface 218 of the plug connector 204 may not include any electrical contacts. However, in some examples, one or more electrical contacts can be additionally, or alternatively, disposed on the second surface 218.

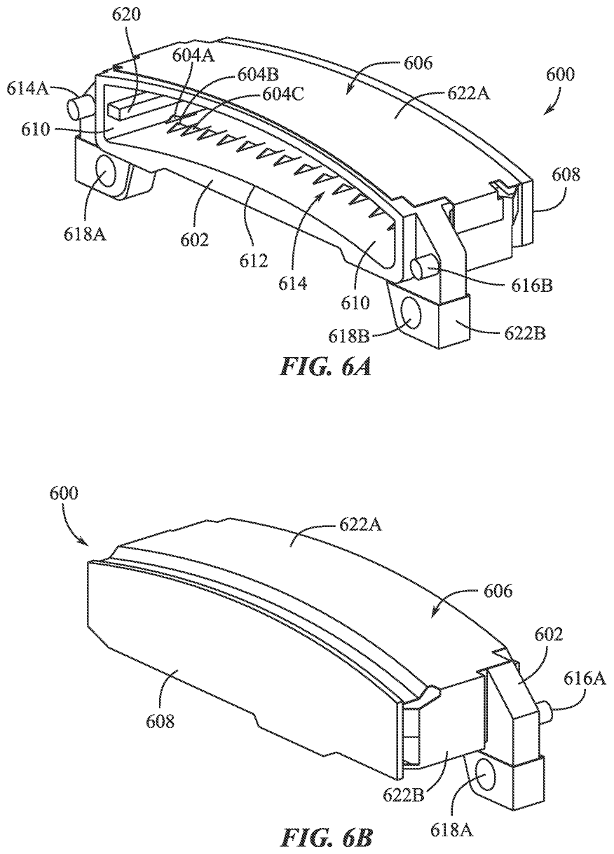

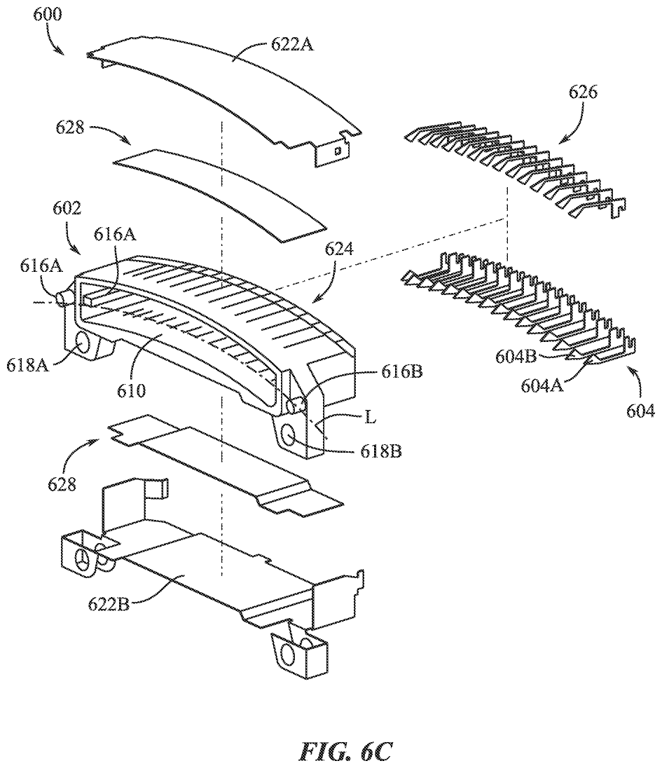

In some examples, the plug connector 204 can form or define one or more channels 220. Each of the one or more channels 220 can be formed within the first surface 216, the second surface 218, or a third surface (i.e., a surface other than the first and second surfaces 216, 218). Additionally, or alternatively, each of the one or more channels 220 can be formed within a third surface 222 and/or a fourth surface 224. For example, as shown in FIGS. 2C and 2D, the channels 220 can be formed on third and fourth surfaces 222, 224 which interconnect the first surface 216 and the second surface 218. Each channel 220 can receive a datum rail (see datum rail 620 in FIG. 6A) of a receptacle connector of the display portion to limit or inhibit movement between the support 200 and the display portion. One or more channels 220 can also be beneficial to enable insertion of the plug connector 204 into a receptacle connector in a limited combination of configurations. For example, a datum rail will prevent insertion of the plug connector 204 within a receptacle connector unless the plug connector has a correlating channel 220. While the channel 220 is illustrated as forming a square or rectangular cross-sectional shape, the channel 220 can form any cross-sectional shape, such as, square, rectangular, semi-circular, triangular, another geometric shape, or a combination thereof. In examples, the cross-sectional shape of the channel 220 can vary along a length of the channel. For example, the channel 220 can form a rectangular cross-sectional shape that tapers to a square cross-section shape along the length of the channel 220.

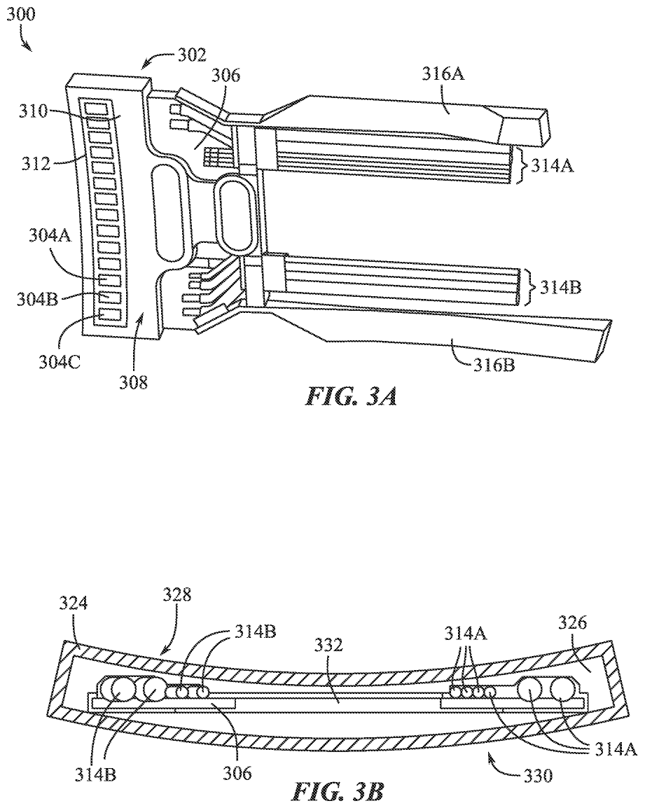

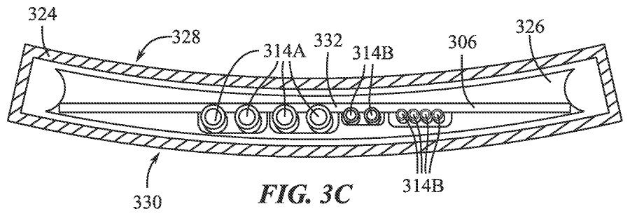

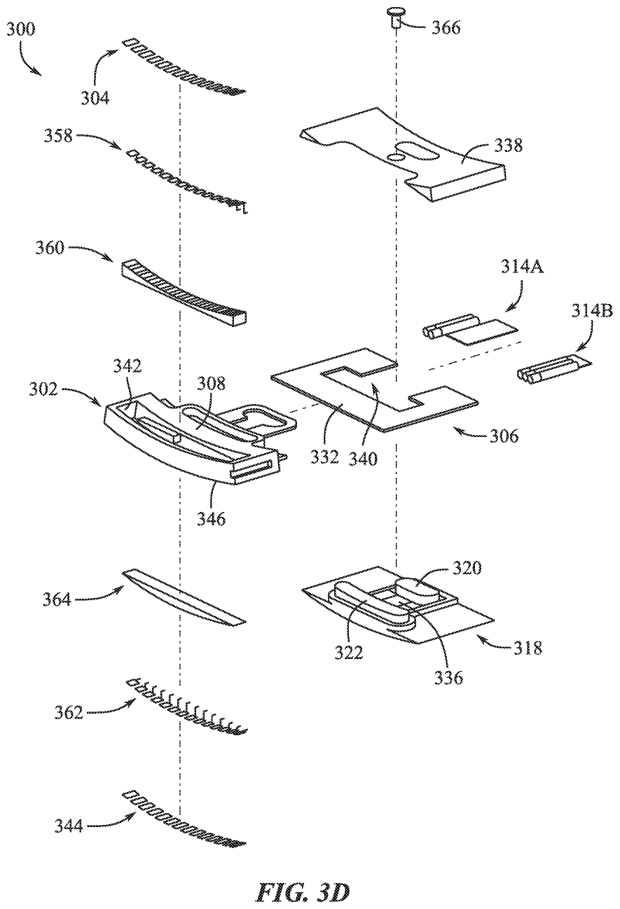

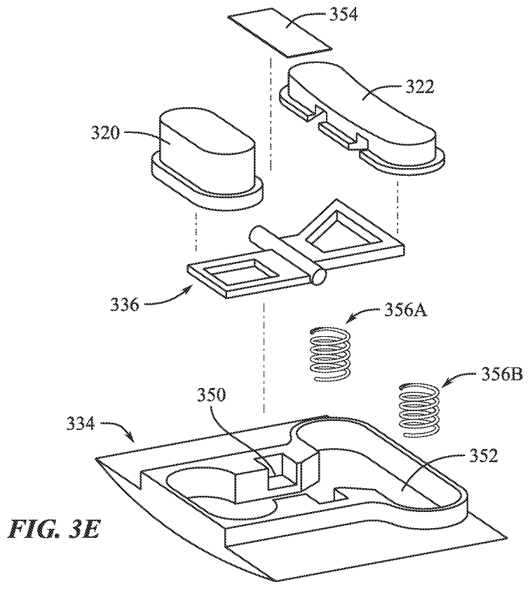

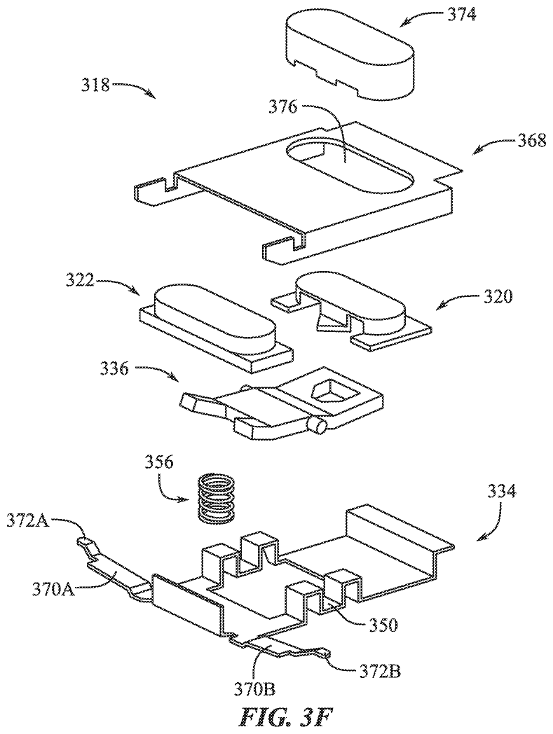

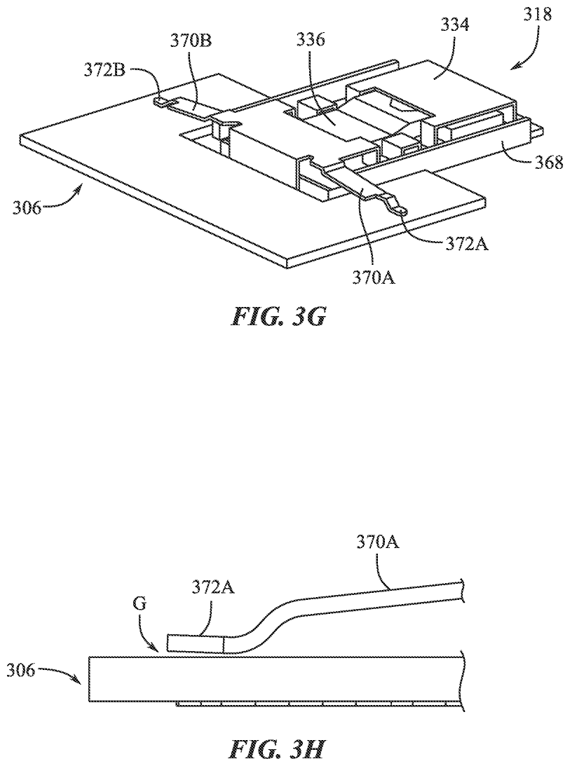

Any number or variety of components in any of the configurations described herein can be included in the electronic device (e.g., HMD). The components can include any combination of the features described herein and can be arranged in any of the various configurations described herein. The structure and arrangement of components of an electronic device having an support and a display portion with structures described herein as well as the concepts regarding various sub-components, can apply not only to the specific examples discussed herein, but to any number of examples in any combination. Examples of supports for an HMD are described below, with reference to FIGS. 3A-3J.

FIG. 3A shows a plug connector 300 including a body 302, one or more electrical contacts 304A, 304B, 304C, and a printed circuit board (PCB) 306. The body 302 can at least partially define a concave surface 308 and a convex surface (not shown). The one or more electrical contacts (e.g., electrical contacts 304A, 304B, 304C) can be disposed within or on the concave surface 308. For example, the body 302 can include a metal portion 310 and a polymer portion 312 which define the concave surface 308. The one or more electrical contacts can be disposed within the polymer portion 312, for example, the one or more electrical contacts can be molded or co-molded within the polymer portion 312. The polymer portion 312 can electrically insulate the one or more electrical contacts from the metal portion 310 of the body 302, such that, the metal portion 310 can function as a grounding path.

In some examples, the one or more electrical contacts (e.g., electrical contacts 304A, 304B, 304C) can be disposed on multiple surfaces of the body 302. For example, one or more electrical contacts can be additionally, or alternatively, disposed on a convex surface 346 defined by the body 302. The one or more electrical contacts (e.g., electrical contacts 304A, 304B, 304C) can be substantially similar to, and can include some or all of, the features of the one or more electrical contacts 124A, 124B, 124C, 214A, 214B, 214C. For example, the electrical contacts can form at least a portion of an electrical path for electrical signals, electrical power, an electrical ground, another electrical communication, or a combination thereof to transfer between the plug connector 300 and a display portion (e.g., display portion 106).

The PCB 306 can be electrically coupled to the one or more electrical contacts (e.g., electrical contacts 304A, 304B, 304C). For example, the PCB 306 can include one or more electrical traces which carry electrical signals and/or electrical power from the one or more electrical contacts (e.g., electrical contacts 304A, 304B, 304C) to an electronic component (e.g., processor, electrical wires, digital logic circuitry, digital processing circuitry, etc.) disposed on the PCB 306. As shown in FIG. 3A, the one or more electrical contacts (e.g., electrical contacts 304A, 304B, 304C) can be electrically coupled to one or more electrical wires 314A, 314B coupled to the PCB 306. The one or more electrical wires 314A, 314B can form at least a portion of an electrical path for electrical signals, electrical power, an electrical ground, another electrical communication, or a combination thereof to transfer between the plug connector 300 and a display portion (e.g., display portion 106). For example, one or more of the electrical wires 314A, 314B can carry electrical power from a receptacle connector (e.g., receptacle connector 206 of the support 200) to the PCB 306. The one or more electrical wires 314A, 314B can be disposed on the PCB 306, for example, the one or more electrical wires 314A, 314B can be soldered to the PCB 306 or an electronic component disposed on the PCB 306.

In some examples, structural members 316A, 316B can be coupled to the plug connector 300. The structural members 316A, 316B can extend away from the plug connector 300 and into an enclosure (e.g., the enclosure 202 of the support 200) to provide a rigid connection between the enclosure and the plug connector 300. In some examples, the enclosure can be molded over the structural members 316A, 316B. Each of the structural members 316A, 316B can be made of a metal, ceramic, a rigid polymer, or a combination thereof. The structural members 316A, 316B can each be coupled (e.g., fastened, welded, molded, adhered, etc.) to one or more of the body 302, the PCB 306, or the electrical wires 314A, 314B.

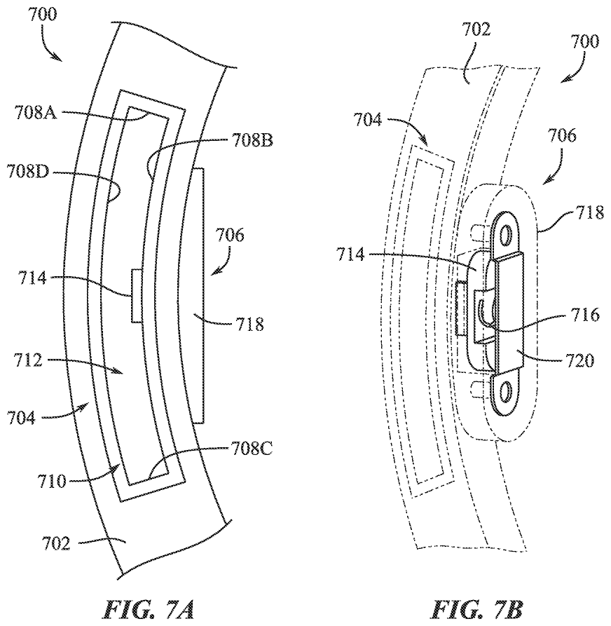

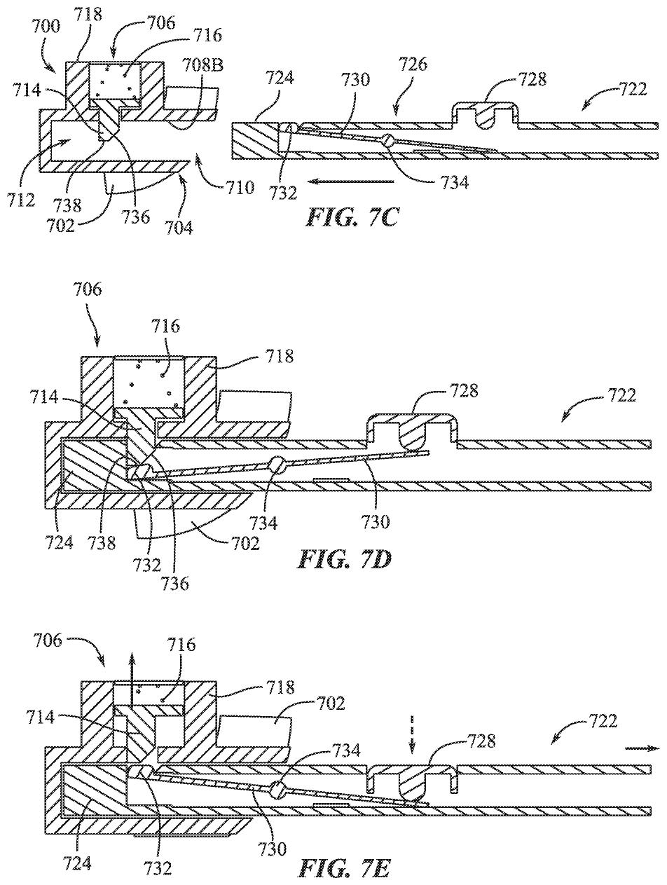

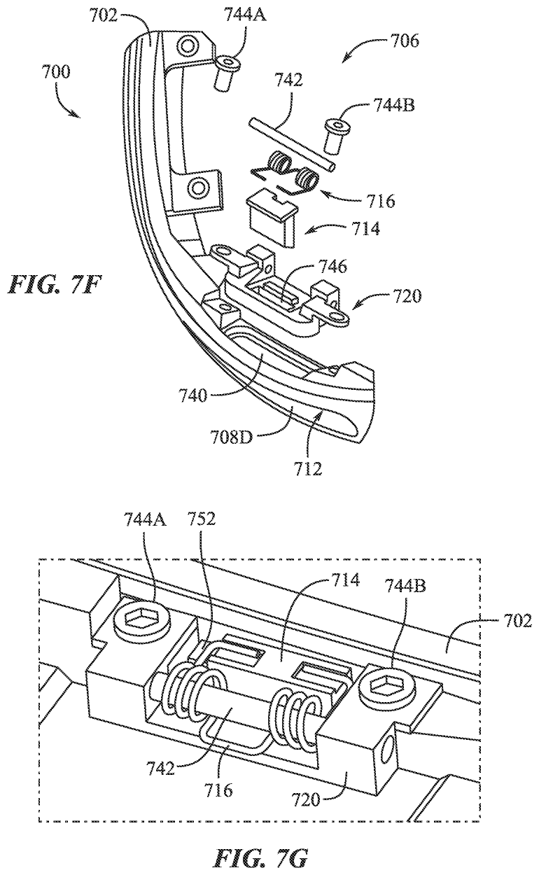

In examples, the plug connector 300 can include a button module 318 including a button 320 and an engagement member 322. While the plug connector 300 is disposed within a receptacle connector (e.g., the receptacle connector 120 of the display portion 106), the receptacle connector can interlock with the engagement member 322 to retain the plug connector 300 to the display portion. A user can disconnect or remove the plug connector 300 from the receptacle connector by pressing the button 320 which disengages the receptacle connector from the engagement member 322. The button module 318 will be described in greater detail herein, for example, with reference to FIGS. 3E-3H and 7A-7G.

FIG. 3B shows a cross-sectional side view of the PCB 306 and electrical wires 314A, 314B disposed within an enclosure 324. The enclosure 324 can form a cavity or internal volume 326 and at least a portion of the PCB 306 and electrical wires 314A, 314B can be disposed within the internal volume 326. The enclosure 326 can define a concave surface 328 and a convex surface 330. The concave surface 328 can be too close to a center 332 of the PCB 306 to accommodate electronic components coupled near or at the center 332 of the PCB 306. As such, one or more electronic components can be electrically coupled on the PCB 306 at a location that is displaced from the center 332. For example, the one or more electrical wires 314A, 314B can be electrically coupled to the PCB 306 at locations that are laterally offset from a center 332 of the PCB 306.

FIG. 3C shows a cross-sectional side view of the PCB 306 and electrical wires 314A, 314B disposed within the enclosure 324 in a different configuration than shown in FIG. 3B. The enclosure 324 can form the cavity or internal volume 326 and at least a portion of the PCB 306 and electrical wires 314A, 314B can be disposed within the internal volume 326. The portion of the enclosure 324 that forms the concave surface 328 can be positioned relatively close to the center 332 of the PCB 306 and limit any space between the portion of the enclosure 324 that forms the concave surface 328 and the PCB 306 to accommodate electronic components on the PCB 306. As such, one or more electronic components can be electrically coupled to the PCB 306 in the space between the portion of the enclosure 324 that forms the convex surface 330 and the center 332 of the PCB 306. In other words, the cross-sectional shape of the enclosure 324 can render certain portions of the PCB 306 better able to accommodate electronic components than other portions of the PCB 306. In some examples, a hybrid of the configurations shown in FIGS. 3B and 3C can be utilized. For example, the electronic components can be coupled to the PCB 306 at offset position from the center 332 of the PCB 306 between the portion of the enclosure 324 that forms the concave surface 328 and the PCB 306 while also having electrical components coupled to the PCB 306 at the center 332 of the PCB 306 between the portion of the enclosure 324 that forms the convex surface 330 and the PCB 306.

FIG. 3D shows an exploded view of the plug assembly 300 including the body 302, the one or more electrical contacts 304 (e.g., electrical contacts 304A, 304B, 304C), the printed circuit board (PCB) 306, and the button module 318. The button module 318 can include the button 320, the engagement member 322, a switch housing 334, a switch structure 336, and a cover member 338. The button module 318 will be discussed in greater detail herein with reference to FIG. 3E. In some examples, the cover member 338 can be affixed to the button module 318, for example, by a fastener 366 extending through the cover member 338, the PCB 306, and coupling to the button module 318.

In some examples, the PCB 306 can define a gap or cutout 340 occupying at least a portion of the center 332 of the PCB 306. The button module 318 can be at least partially disposed at the gap or cutout 340. In other words, one or more of the components that make up the button module 318 can be disposed within the gap or cutout 340. For example, as shown in FIG. 3D, the PCB 306 can include a T-shaped cutout 340 and the engagement member 322 can extend through the T-shaped cutout 340. While the cutout 340 is described as T-shaped, the cutout 340 can resemble any single geometric shape or combination of geometric shapes. The electrical wires 314A, 314B can be coupled to surfaces of the PCB 306 that are separated or spaced apart from one another by the cutout 340. For example, each of the electrical wires 314A, 314B can be affixed to the PCB 306 by respective support structures 348A, 348B. Additionally, or alternatively, the particular electrical wires 314A, 314B having a relatively lesser diameter can be disposed nearer the center 332 if the PCB 306 than the particular electrical wires 314A, 314B having relatively greater diameter. In other words, the particular electrical wires 314A, 314B having larger diameters can be disposed nearer the periphery of the PCB 306 than the particular electrical wires 314A, 314B having smaller diameters.

In some examples, each of the one or more electrical contacts 304 can be coupled to a respective contact carrier 358. Each of the contact carriers 358 can be electrically coupled to the PCB 306 and form an electrical path between the electrical contacts 304 and the PCB 306. Each of the contact carriers 358 can position an electrical contact 304 at a particular height and angle relative to the PCB 306, such that, each electrical contact 304 is capable of forming an electrical connection between a correlating electrical contact (e.g., electrical contacts 604 shown in FIG. 6A) while the plug connector 300 is disposed within a receptacle connector (e.g., receptacle connector 600). The contact carriers 358 can be disposed on and/or within a stand-off 360 defining a concave surface. The polymer portion 312 can be overmolded or overlaid over at least one of the contact carriers 358 and the stand-off 360. The polymer portion 312 can be coupled, molded, or otherwise affixed within a recess or through-hole 342 defined by the metal portion 310 of the body 302. The polymer portion 312 can electrically insulate the one or more electrical contacts 304 and/or the contact carriers 358 from the metal portion 310 of the body 302, such that, the metal portion 310 can function as a grounding path. In examples, the electrical contacts 304, the polymer portion 312, and the metal portion 310 can define the concave surface 308.

As shown in FIG. 3D, the plug connector 300 can also, or alternatively, include one or more electrical contacts 344 disposed on a convex surface 346 at least partially defined by the body 302. The one or more electrical contacts 344 can be electrically coupled to one or more of the electrical wires 314A, 314B through traces formed within the PCB 306. The one or more electrical contacts 344 can be substantially similar to, and can include some or all of, the features of the one or more electrical contacts 124A, 124B, 124C, 214A, 214B, 214C. For example, the electrical contacts 344 can form at least a portion of an electrical path for electrical signals, electrical power, an electrical ground, another electrical communication, or a combination thereof to transfer between the plug connector 300 and a display portion (e.g., display portion 106). In some examples, each of the one or more electrical contacts 344 can be coupled to a respective contact carrier 362. Each of the contact carriers 362 can be electrically coupled to the PCB 306 and form an electrical path between the electrical contacts 344 and the PCB 306. Each of the contact carriers 362 can position an electrical contact 344 at a particular height and angle relative to the PCB 306, such that, each electrical contact 344 is capable of forming an electrical connection between a correlating electrical contact (e.g., electrical contacts 626 shown in FIG. 6C) while the plug connector 300 is disposed within a receptacle connector (e.g., receptacle connector 600).

In some examples, the contact carriers 362 can be disposed on and/or within a stand-off 364 defining a convex surface. The polymer portion 312 can be overmolded or overlaid over at least one of the contact carriers 362 and the stand-off 364. The polymer portion 312 can be coupled, molded, or otherwise affixed within a recess or through-hole 342 defined by the metal portion 310 of the body 302. The polymer portion 312 can electrically insulate the one or more electrical contacts 344 and/or the contact carriers 362 from the metal portion 310 of the body 302, such that, the metal portion 310 can function as a grounding path. In examples, the electrical contacts 344, the polymer portion 312, and the metal portion 310 can define the convex surface 346. In some examples, the electrical contacts 304 can represent a first set of electrical contacts and the electrical contacts 344 can represent a second set of electrical contacts.

FIG. 3E shows an exploded view of the button module 318 including the button 320, the engagement member 322, the switch housing 334, and the switch structure 336. In some examples, the switch structure 336 can be pivotably disposed within the switch housing 334 such that the switch structure 336 can rock or pivot relative to the switch housing 334. For example, the switch housing 334 can define a pivot point 350 within a recess 352 of the switch housing. The switch structure 336 can be disposed within the recess 352 and rock or pivot about the pivot point 350. In examples, the switch structure 336 can be affixed within the recess 352, for example, by an adhesive tape 354. Each of the button 320 and the engagement member 322 can be at least partially disposed within the recess 352 and engaging the switch structure 336. For example, the button 320 and the engagement member 322 can be clipped, adhered, fastened, or otherwise affixed to the switch structure 336 such that pivotal movement of the switch structure 336 causes the button 320 and the engagement member 322 to move relative to the switch housing 334.

In examples, one or more biasing elements 356A, 356B can be disposed within the recess 352. The one or biasing elements 356A, 356B can bias the engagement member 322 and/or the switch structure such that the engagement member 322 is biased to extend out of the recess 352. While the biasing elements 356A, 356B are shown as coil springs in FIG. 3E, the biasing elements 356A, 356B can be any component capable of exerting a biasing force on the engagement member 322, such as, leaf springs, a foam, domes, or a combination thereof.

In some examples, when the plug connector 300 is disposed within a receptacle connector (e.g., the receptacle connector 120 of the display portion 106), the engagement member 322 can be pressed deeper into the recess 352 and cause the button to extend further out of the recess 352. To remove the plug connector 300 from the receptacle connector, a user can press the button 320 causing the engagement member 322 to extend further out of the recess 352. Operation of the button module 318 relative to a receptacle connector will be discussed in greater detail herein with reference to FIGS. 7A-7G.

FIG. 3F shows another example of a button module 318 including a top plate 368 which, along with the switch housing 334, encloses or partially encloses the components (e.g., the button 320, the engagement member 322, the biasing element 356, the switch structure 336) of the button module 318. In some examples, the button module 318 can include a single biasing element 356 (as shown in FIG. 3F) or multiple biasing elements 356A, 356B (as shown in FIG. 3E). The one or more biasing elements 356 can include at least one biasing element 356 exerting a biasing force on the button 320. Additionally, or alternatively, the one or more biasing elements 356 can include at least one biasing element 356 exerting a biasing force on the engagement member 322. The switch structure 336 can be substantially similar to, and can include some or all of, the features of the switch structure 336 shown in FIG. 3E. For example, the switch structure 336 can be pivotably disposed within the switch housing 334 such that the switch structure 336 can rock or pivot relative to the switch housing 334. The switch housing 334 can define a pivot point 350 and switch structure 336 can rock or pivot about the pivot point 350. While pivoting, the switch structure 336 can displace the engagement member 322 and the button 320. For example, a user can press the button 320 (i.e., displace the button 320 toward the switch housing 334) and cause the engagement member 322 to be displaced away from the switch housing 334. Alternatively, an engagement feature (see FIG. 7A) can press the engagement member 322 (i.e., displace the engagement member 322 toward the switch housing 334) and cause the button 320 to be displaced away from the switch housing 334. In some examples, the button 320 can include a cap 374 disposed over the button 320 and extending through an aperture 376 defined by the top plate 368.

As shown in FIGS. 3F-3H, the button module 318 can include one or more arms 370A, 370B that electrically couple to the PCB 306. For example, each of the one or more arms 370A, 370B can extend from the switch housing 334 to contact the PCB 306 to electrically ground the PCB 306 to the button module 318. In some examples, each of the one or more arms 370A, 370B can include a respective distal end 372A, 372B. Each of the distal ends 372A, 372B can be plated to improve electrical transference or conductivity between the PCB 306 and the arm 370A, 370B. For example, one or more of the distal ends 372A, 372B can be at least partially plated with gold, silver, copper, platinum, nickel, another metal, or a combination thereof. In some examples, one or both of the distal ends 372A, 372B can be soldered to the PCB 306, for example, the distal ends 372A, 372B can be soldered to electrically and physically couple the button module 318 to the PCB 306. As shown in FIG. 3H, one or more of the distal ends 372A, 372B can be angled relative to the PCB 306 to form a gap G within which solder or another electrically conductive material can flow and set to physically and/or electrically couple the button module 318 to the PCB 306.

FIG. 3I shows another example of a plug connector 300 including a body 302, one or more electrical contacts 304A, 304B, 304C, and a printed circuit board (PCB) 306. The body 302 can be substantially similar to, and can include some or all of, the features of the body 302 shown in FIG. 3A. For example, the body 302 can at least partially define the concave surface 308 and the convex surface 346 (not shown). The one or more electrical contacts (e.g., electrical contacts 304A, 304B, 304C) can be disposed within or on the concave surface 308. In some examples, the plug connector 300 can include a singular structural member 316 (as opposed to the distinct structural members 316A, 316B shown in FIG. 3A). The structural member 316 can be at least partially inserted into the body 302 of the plug connector 300. For example, the structural member 316 can be at least partially inserted into blind-holes 380A, 380B formed within the body 302 to affix the structural member 316 to the body 302. The structural member 316 can be welded, adhered, fastened, or otherwise affixed within the blind-holes 380A, 380B. The structural member 316 can provide a rigid connection between the enclosure (e.g., the enclosure 202 of the support 200) and the plug connector 300.

In some examples, the plug connector 300 can include one or more flexible electrical connectors 378A, 378B. Each of the one or more flexible electrical connectors 378A, 378B can be disposed within a respective channel 382A, 382B defined by the structural member 316. The one or more flexible electrical connectors 378A, 378B can each form at least a portion of an electrical path for electrical signals, electrical power, an electrical ground, another electrical communication, or a combination thereof to transfer between the plug connector 300 and a display portion (e.g., display portion 106). For example, one or more of the flexible electrical connectors 378A, 378B can carry electrical power to the PCB 306. The one or more flexible electrical connectors 378A, 378B can be disposed on the PCB 306, for example, the one or more flexible electrical connectors 378A, 378B can be soldered to the PCB 306 or an electronic component disposed on the PCB 306.

In some examples, one or more of the flexible electrical connectors 378A, 378B can be crimped, folded, bent, or otherwise manipulated along their longitudinal axis to enable flexibility and assembly of the plug connector 300. For example, each of the one or more flexible electrical connectors 378A, 378B can include alternating folds that enable the effective length of the respective flexible electrical connector to be varied while maintaining an electrical and physical connection to the PCB 306. This configuration can enable the body 302 to be affixed to the structural member 316 after the flexible electrical connectors 378A, 378B have been affixed to the PCB 306. In other words, the flexible electrical connectors 378A, 378B can be long enough to enable assembly of the plug connector 300 yet the excess length of the flexible electrical connectors 378A, 378B can be subsequently taken up within the sleeve 384 after the structural member 316 is affixed to the body 302. In this manner, the excess length of the flexible electrical connector does not impede assembly of the plug connector 300.

In examples, the one or more electrical wires 314A, 314B can be coupled to the one or more flexible electrical connectors 378A, 378B to form an electrical path for electrical signals, electrical power, an electrical ground, another electrical communication, or a combination thereof to transfer between the plug connector 300 and a display portion (e.g., display portion 106). For example, one or more of the electrical wires 314A, 314B can carry electrical power from a receptacle connector (e.g., receptacle connector 206 of the support 200) to the flexible electrical connectors 378A, 378B. The one or more flexible electrical connectors 378A, 378B can be disposed on the PCB 306, for example, the one or more flexible electrical connectors 378A, 378B can be soldered or otherwise affixed to the PCB 306 or an electronic component disposed on the PCB 306. In some examples, each of the one or more electrical wires 314A, 314B can be disposed within a respective channel 382A, 382B defined by the structural member 316.

In some examples, at least a portion of the sleeve 384 can enclose or cover at least a portion of the structural member 316. For example, the sleeve 384 can form or define a cavity or volume that at least partially surrounds the structural member 316. In some examples, the sleeve 384 can form or define apertures 386A, 386B in fluid communication with the cavity or volume and provide access to the respective channels 382A, 382B of the structural member 316. The one or more electrical wires 314A, 314B can be affixed, adhered, or otherwise coupled to the sleeve 384 and extend through the apertures 386A, 386B to couple to the flexible electrical connectors 378A, 378B. In examples, the sleeve 384 can be molded, machined, stamped and folded, or otherwise manufactured.

FIG. 3J shows an example of a plug connector 300 including a body 302, one or more electrical contacts 304A, 304B, 304C, and a printed circuit board (PCB) 306. The body 302 can be substantially similar to, and can include some or all of, the features of the body 302 shown in FIG. 3A. For example, the body 302 can at least partially define the concave surface 308 and the convex surface 346 (not shown). The one or more electrical contacts (e.g., electrical contacts 304A, 304B, 304C) can be disposed within or on the concave surface 308. FIG. 3J shows a configuration of the plug connector 300 wherein each of the electrical wires 314A, 314B are crossed over one another to enable the body 302 and PCB 306 to be removed from the sleeve 384 without disconnecting the electrical wires 314A, 314B from the PCB 306. In other words, the electrical wires 314A, 314B can have a greater length if crossed which eases assembly and disassembly of the plug connector 300.

Any number or variety of components in any of the configurations described herein can be included in the electronic device (e.g., HMD). The components can include any combination of the features described herein and can be arranged in any of the various configurations described herein. The structure and arrangement of components of an electronic device having an support and a display portion with structures described herein as well as the concepts regarding various sub-components, can apply not only to the specific examples discussed herein, but to any number of examples in any combination. Examples of supports for an HMD are described below, with reference to FIG. 4.

FIG. 4 shows a side view of a plug connector 400 partially disposed within an enclosure 402 and including a set of wires 404 extending from the plug connector 400 to a receptacle connector 406 disposed within the enclosure 402. The plug connector 400 can be substantially similar to, and can include some or all of, the features of the plug connectors 118, 204, 300. For example, the plug connector 400 can include a body 408, one or more electrical contacts 410A, 410B, 410C, and a printed circuit board (PCB) 412. The enclosure 402 can be substantially similar to, and include some or all of, the features of the enclosures 112, 202, 324. For example, the enclosure 402 can form an internal volume 414 and the set of wires 404 can extend within the internal volume 414 to electrically couple the plug connector 300 to the receptacle connector 406.

In some examples, one or more other electrical components 416 can be disposed at least partially within the internal volume 414. For example, the electrical component 416 can be a processor, display, input region, or audio component (e.g., a speaker or a microphone) disposed within the internal volume 414 of the enclosure 402. One or more of the set of wires 404 can extend from the receptacle connector 406 and/or the plug connector 400 and electrically couple to the one or more electrical components 416 to provide electrical power, electrical signals, a grounding path, or a combination thereof.

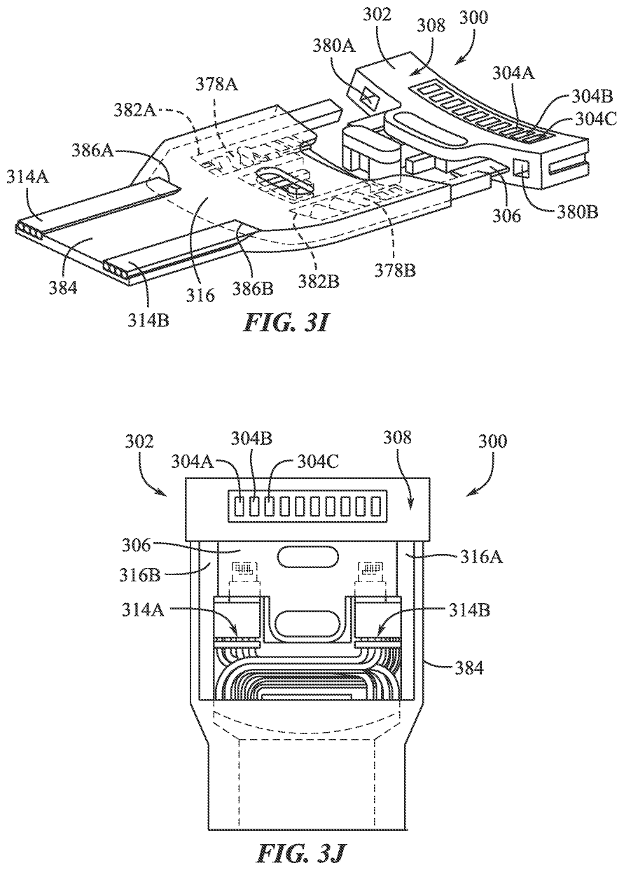

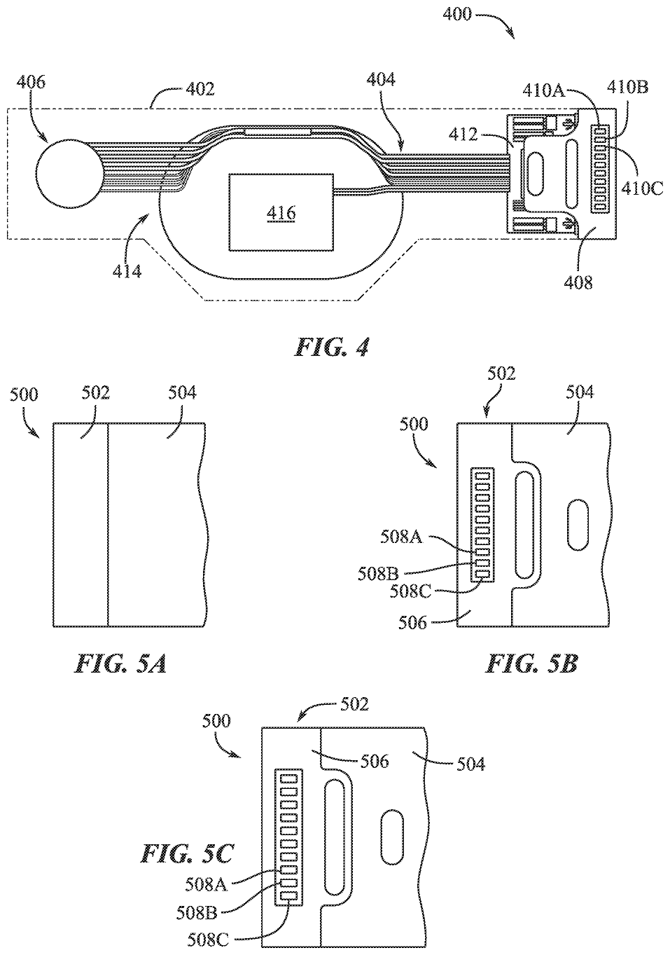

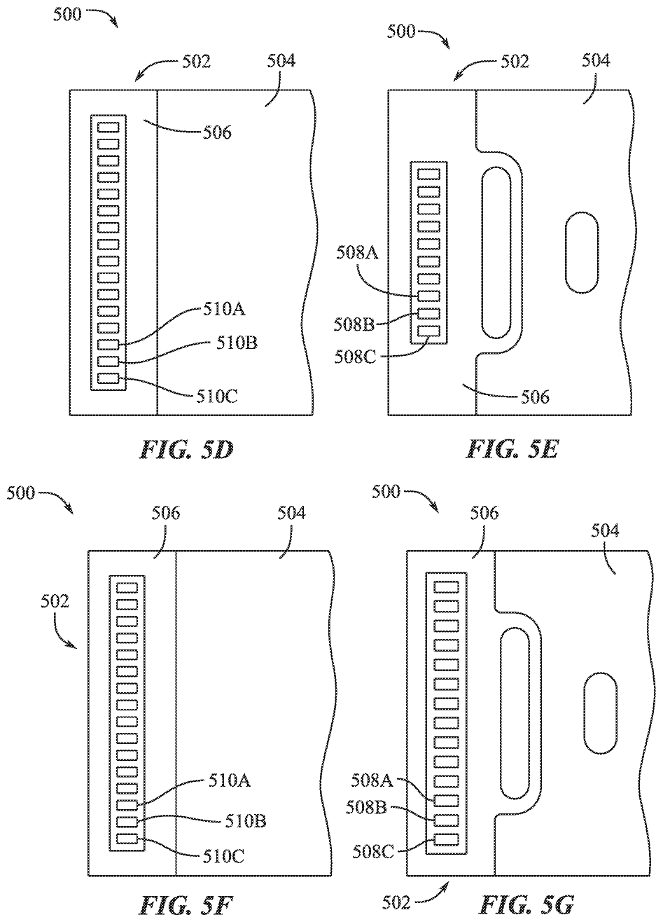

Any number or variety of components in any of the configurations described herein can be included in the electronic device (e.g., HMD). The components can include any combination of the features described herein and can be arranged in any of the various configurations described herein. The structure and arrangement of components of an electronic device having a support and a display portion with structures described herein as well as the concepts regarding various sub-components, can apply not only to the specific examples discussed herein, but to any number of examples in any combination. Examples of supports for an HMD including various configurations of electrical contacts are described below, with reference to FIGS. 5A-5G.

FIGS. 5A and 5B show a configuration of a proximal end of a support 500 including a plug connector 502 partially disposed within an enclosure 504. The plug connector 502 can be substantially similar to, and can include some or all of, the features of the plug connectors 118, 204, 300, 400. For example, the plug connector 502 can include a body 506 and one or more electrical contacts 508A, 508B, 508C. The enclosure 504 can be substantially similar to, and include some or all of, the features of the enclosures 112, 202, 324, 402. FIG. 5A shows a first side of the proximal end of the support 500 which does not include any electrical contacts. FIG. 5B shows a second side of the proximal end of the support 500 including ten distinct electrical contacts, including electrical contacts 508A, 508B, and 508C. Thus, the plug connector 502 illustrated in FIGS. 5A and 5B can include a total of ten electrical contacts (i.e., zero electrical contacts on the first side and ten electrical contacts of the second side). FIG. 5C shows another configuration of the second side of the proximal end of the support 500 in which the ten distinct electrical contacts are enlarged and evenly spaced across a greater width of the second side. In other words, the size of each electrical contact (e.g., electrical contacts 508A, 508B, 508C) and spacing between each individual electrical contact can be greater than the spacing between electrical contacts shown in FIG. 5B.

FIG. 5D and 5E show another configuration of the proximal end of the support 500. FIG. 5D shows the first side including sixteen distinct electrical contacts, including electrical contacts 510A, 510B, and 510C. FIG. 5E shows the second side including ten distinct electrical contacts, including electrical contacts 508A, 508B, and 508C. Thus, the plug connector 502 illustrated in FIGS. 5D and 5E can include a total of 26 electrical contacts (i.e., sixteen electrical contacts on the first side and ten electrical contacts of the second side). FIGS. 5F and 5G show yet another configuration of the proximal end of the support 500. FIG. 5F shows the first side including sixteen electrical contacts, including electrical contacts 510A, 510B, and 510C. FIG. 5G shows the second side including fourteen electrical contacts, including electrical contacts 508A, 508B, and 508C. Thus, the plug connector 502 illustrated in FIGS. 5F and 5G can include a total of 30 electrical contacts (i.e., sixteen electrical contacts on the first side and fourteen electrical contacts of the second side).

The number of electrical contacts (i.e., the quantity of electrical contacts on one or both sides of the plug connector 502) can correlate to a quantity of data the support 500 can send or receive. For example, the plug connector 502 can include between ten and sixteen total pins between the first side and the second side to support a relatively low data transfer rate, such as about 1 gigabit per second or more, when the HMD is operated by a consumer who generally uses the device for entertainment. Additionally, or alternatively, in some examples, the plug connector 502 can include between sixteen and thirty total pins between the first side and the second side to support a relatively high data transfer rate, such as about 10 gigabits per second or more, when the HMD is operated by a developer who uploads and generates content for the HMD (e.g., applications, games, etc.).

While the example supports 500 shown in FIGS. 5A-5G are illustrated as having a particular quantity of electrical contacts, the support 500 can include a plug connector 502 having at least 3 electrical contacts, between 3 electrical contacts and 10 electrical contacts, between 10 electrical contacts and 20 electrical contacts, between 20 electrical contacts and 30 electrical contacts, or more than 30 electrical contacts. Moreover, the electrical contacts can be arranged on one or both sides of the plug connector 502. For example, the first side of the plug connector 502 can have an equivalent number of electrical contacts than the second side of the plug connector 502. In other examples, the first side of the plug connector 502 can have a different number of electrical contacts than the second side of the plug connector 502 (i.e., more or fewer electrical contacts).

Any number or variety of components in any of the configurations described herein can be included in the electronic device (e.g., HMD). The components can include any combination of the features described herein and can be arranged in any of the various configurations described herein. The structure and arrangement of components of an electronic device having a support and a display portion with structures described herein as well as the concepts regarding various sub-components, can apply not only to the specific examples discussed herein, but to any number of examples in any combination. Examples of receptacle connections for a display portion of an HMD are described below, with reference to FIGS. 6A-6C.

FIGS. 6A and 6B show perspective views of a receptacle connector 600 including a receptacle housing 602, one or more electrical contacts (e.g., electrical contacts 604A, 604B, 604C), a cover member 606, and a printed circuit board (PCB) 608. In some examples, the receptacle housing 602 can be manufactured from an electrically insulating material, such as, a polymer or ceramic and can be molded, machined, cast, stamped, or a combination thereof. The receptacle housing 602 can one include or more side walls 610 defining an aperture 612 and an internal volume 614. In examples, at least a portion of a support (e.g., the support 108) can be inserted into the aperture 612 and received within the internal volume 614. The aperture 612 can define a cross-sectional shape having a longitudinal axis L that curves or bends (see FIG. 6C). For example, the aperture 612 can have a cross-sectional shape that substantially conforms to a cross-sectional shape of a plug connector (e.g., plug connector 300). In other words, the one or more side walls 610 of the receptacle housing 602 can define a convex surface and a concave surface that correlate in size, shape, and contour with the convex and concave surfaces 308, 346 of the plug connector 300.

In some examples, the receptacle housing 602 can form or define one or more protrusions 616A, 616B which assist in aligning and retaining the receptacle housing 602 relative to a display portion (e.g., display portion 106) of the HMD. For example, the display portion can include an enclosure having one or more features which engage the one or more protrusions 616A, 616B to align and/or retain receptacle housing 602 relative to the enclosure. Additionally, or alternatively, the receptacle housing 602 can form or define one or more holes 618A, 618B which also assist in aligning and retaining the receptacle housing 602 relative to a display portion (e.g., display portion 106) of the HMD. For example, the display portion can include an enclosure having one or more features (pegs, fasteners, clips, etc.) which engage the one or more holes 618A, 618B to align and/or retain receptacle housing 602 relative to the enclosure.

In examples, the receptacle housing 602 can form one or more datum rails 620.

Each datum rail 620 can be disposed on a respective side wall 610 and extend into the internal volume 614. For example, the one or more datum rails 620 can be molded, co-molded, or otherwise formed with the receptacle housing 602 as a singular and unitary structure. Each of the datum rails 620 can be received within respective channels (e.g., channel 220) defined by the plug connector 204 to provide a rigid connection between the support and the display portion (i.e., limit motion or free play between the support and the display portion). Additionally, or alternatively, the one or more datum rails 620 can limit or prevent the support from being inserted into the receptacle connector 600 in an undesirable orientation and/or configuration.

The one or more electrical contacts (e.g., electrical contacts 604A, 604B, 604C) can extend from one of the side walls 610 into the internal volume 614. The one or more electrical contacts (e.g., electrical contacts 604A, 604B, 604C) can provide electrical signals, electrical power, a grounding path, another electrical communication, or a combination thereof to the PCB 608. In some examples, a first set of electrical contacts, including electrical contacts 604A, 604B, 604C, can be disposed on a first side of the internal volume 614 while a second set of electrical contacts (see FIG. 6C) can be disposed on a second, opposite, side of the internal volume 614.

In some examples, the cover member 606 can include an upper or first portion 622A and a lower or second portion 622B. The first portion 622A and the second portion 622B can be machined, molded, stamped, extruded, or otherwise manufactured from one or more materials, such as a metal, a ceramic, or a polymer. In some examples, the second portion 622B can at least partially form the holes 618A, 618B. Each of the first portion 622A and 622B can provide a support structure for the receptacle connector 600. In examples, the first portion 622A and 622B can shield the receptacle connector 600 from propagating errant electromagnetic waves out of the receptacle connector 600.

The PCB 608 can be electrically coupled to the one or more electrical contacts (e.g., electrical contacts 604A, 604B, 604C). For example, the PCB 608 can include one or more electrical traces which carry electrical signals and/or electrical power from the one or more electrical contacts (e.g., electrical contacts 604A, 604B, 604C) to an electronic component (e.g., processor, electrical wires, digital logic circuitry, digital processing circuitry, etc.) disposed on the PCB 608. The PCB 608 and/or the one or more electronic components electrically coupled to the PCB 608 can be electrically coupled to one or more electrical wires (not shown) to form at least a portion of an electrical path for electrical signals, electrical power, an electrical ground, another electrical communication, or a combination thereof to transfer between the receptacle connector 600 and a display or other electronic components within the display portion (e.g., display portion 106). Similarly, the PCB 608 can form at least a portion of an electrical path for electrical signals, electrical power, an electrical ground, another electrical communication, or a combination thereof to transfer between the receptacle connector 600 and the plug connector of the support (e.g., support 200).

FIG. 6C shows an exploded view of the receptacle connector 600 including the receptacle housing 602. The receptacle housing 602 can form slits or slots 624 within the one or more side walls 610 which enable the first set of electrical contacts 604 to extend through the side wall 610 and into the internal volume 614. In some examples, the receptacle housing 602 can form slits or slots 624 within the one or more side walls 610 which enable a second set of electrical contacts 626 to extend through the side wall 610 and into the internal volume 614. The second set of electrical contacts 626 can extend into the internal volume 614 from a different side wall 610 that the first set of electrical contacts 604. In some examples, a plug connector can be devoid of electrical contacts to make contact with both the first set of electrical contacts 604 and the second set of electrical contacts 626. In other words, one example of a support, like the support 500 shown in FIGS. 5A and 5B, can include electrical contacts 508 that only utilize one of the sets of electrical contacts 604, 626 shown in FIG. 6C. However, another example of a support, like the support 500 shown in FIGS. 5D and 5E, can include electrical contacts 508, 510 that utilize both sets of electrical contacts 604, 626 shown in FIG. 6C. Thus, a single configuration of the receptacle connector 600 having two sets of electrical contacts 604, 626 can be operable with multiple configurations of supports (i.e., supports having varied electrical contact configurations, as described with reference to FIGS. 5A-5G).

As shown in FIG. 6C, in some examples, one or more of the electrical contacts 604 can be longer than other electrical contacts. For example, the electrical contact 604A can be shorter than the electrical contact 604B to enable the electrical contact 604B to physically contact a correlating electrical contact (e.g., one of the electrical contacts 510) despite partial removal of the plug connector (e.g., plug connector 502) from the receptacle connector 600. For example, the electrical contact 604B can remain in physical/electrical contact with the correlating electrical contact of the plug connector while the plug connector is partially removed from the receptacle connector 600 and the electrical contact 604A is no longer electrically or physically contacting a correlating electrical contact of the plug connector. That is, some of the electrical contacts 604 can maintain an electrical connection longer than other electrical contacts 604 while the plug connector is being removed from the receptacle connector 600. While the electrical contact 604A is out of contact from its correlating electrical contact on the plug connector but before the electrical contact 604B moves out of contact with its correlating electrical contact on the plug connector, a duration of time can pass. The duration of time can be sufficient to enable the HMD to mitigate any destructive effects of unintentionally extracting the plug connector from the receptacle connector 600. Additionally, or alternatively, the size, shape, and position of each of the electrical contacts 510 (shown in FIGS. 5A-5G) can be varied to impact the duration of time when the electrical contact 604A is out of contact from its correlating electrical contact of the plug connector but before the electrical contact 604B moves out of contact with its correlating electrical contact of the plug connector. For example, one or more of the electrical contacts 510 can be enlarged or sized to maintain an electrical connection with one or more of the electrical contacts 604 while the plug connector is partially removed from the receptacle connector 600.

In some examples, one or more intermediate layers 628 can be disposed between the first portion 622A and the receptacle housing 602. Additionally, or alternatively, one or more intermediate layers 628 can be disposed between the second portion 622B and the receptacle housing 602. The one or more intermediate layers 628 can electrically insulate the receptacle housing 602 and the electrical contacts 604, 626 from the respective first and second portions 622A, 622B. The one or more intermediate layers 628 can be adhered, fastened, welded, or otherwise affixed to the cover member 606 and/or the receptacle housing 602. For example, each of the intermediate layers 628 can be a polymer based adhesive tape.

Any number or variety of components in any of the configurations described herein can be included in the electronic device (e.g., HMD). The components can include any combination of the features described herein and can be arranged in any of the various configurations described herein. The structure and arrangement of components of an electronic device having a support and a display portion with structures described herein as well as the concepts regarding various sub-components, can apply not only to the specific examples discussed herein, but to any number of examples in any combination. Examples of receptacle connections for a display portion of an HMD and plug connectors of a support for the HMD are described below, with reference to FIGS. 7A-10B.

FIG. 7A shows an enlarged view of a display portion 700 including an enclosure 702, a receptacle connector 704, and an interlock 706. The enclosure 702 can define an internal volume at least partially retaining one or more electronic components of the display portion 700. For examples, the enclosure 702 can at least partially retain the receptacle connector 704, the interlock 706, printed circuit boards, processors, electrical wires, digital logic circuitry, digital processing circuitry, a combination thereof, or any other electronic component.). The receptacle connector 704 can be substantially similar to, and can include some or all of, the features of the receptacle connectors 120, 600. For example, the receptacle connector 704 can be disposed within or on the enclosure 702 and operably couple a support (e.g., support 500) to the display portion 700 (see FIGS. 1A and 1B). The receptacle connector 704 can include one or more side walls 708A, 708B, 708C, 708D defining an aperture 710 and an internal volume 712.

FIG. 7B shows a detailed view of the interlock 706 coupled to the enclosure 702. The interlock 706 can include a tooth or engagement feature 714 extending through an aperture (see FIG. 7F) within the side wall 708B of the receptacle connector 704. The engagement feature 714 can extend into the internal volume 712 of the receptacle connector 704. While a plug connector (e.g., plug connector 300) is disposed within the receptacle connector 704, the engagement feature 714 can contact a portion of the plug connector to retain the plug connector within the internal volume 712 of the receptacle connector 704. For example, the engagement feature 714 can contact an engagement member (e.g., engagement member 322) of the support to the display portion 700. The interaction between the engagement feature 714 and the engagement member to couple and decouple the support to the display portion 700 will be discussed in detail herein with reference to FIGS. 7C-7G.

In some examples, the engagement feature 714 can be movable relative to the side wall 708B to enable insertion and extraction of the plug connector into the receptacle connector 704. For example, one or more biasing elements 716 can be disposed within a housing 718 of the interlock 706 and between the engagement feature 714 and a frame 720, other structure within the housing 718, or the housing 718 itself. The one or biasing elements 716 can bias the engagement feature 714 such that the engagement feature 714 is movable relative to the side wall 708B (i.e., the engagement feature 714 can move in and out of the internal volume 712). While the plug connector is inserted into the receptacle connector 704, the biasing element 716 can bias the engagement feature 714 to extend toward the plug connector and thereby retain the plug connector within the receptacle connector 704. While the biasing element 716 is shown as a single coil spring in FIG. 7B, the biasing element(s) 716 can be any component capable of exerting a biasing force on the engagement feature 714, such as, leaf springs, a foam, domes, or a combination thereof.

FIGS. 7C-7E show example steps of interconnecting and detaching a support 722 and the receptacle connector 704 of the display portion 700. The support 722 can be substantially similar to, and can include some or all of, the features of the supports 108, 200, 500. For example, the support 722 can include a plug connector 724 having a button module 726. The button module 726 can be substantially similar to, and can include some or all of, the features of the button module 318. For example, the button module 726 can include a button 728, a switch structure 730, and an engagement member 732. FIG. 7C illustrates the support 722 and the receptacle connector 704 prior to insertion of the plug connector 724 within the internal volume 712 of the receptacle connector 704.

FIG. 7D illustrates the plug connector 724 retained within the receptacle connector 704 by the interlock 706 and the button module 726. In some examples, the engagement feature 714 can exert a force on the engagement member 732 to cause the engagement member 732 to recede within the button module 726. In other words, the force exerted on the engagement member 732 by the engagement feature 714 can cause the switch structure 730 to pivot about a pivot point 734. When the switch structure 730 pivots about the pivot point 734, the switch structure 730 can bias the button 728 to protrude or further protrude from the button module 726. In other words, the switch structure 730 can cause the button 728 to move in a direction that is substantially opposite to a direction the engagement member 732 is biased by the engagement feature 714. While the engagement member 732 is receded within the button module 726, the engagement feature 714 can extend into the button module 726 and interlock with the plug connector 724 to prevent removal of the plug connector 724 from the receptacle connector 704. In some examples, one or more surfaces 736 of the engagement feature 714 can be obtuse relative to an engagement surface 738 of the engagement feature 714 to ease insertion of the plug connector 724 into the receptacle connector 704.

FIG. 7E illustrates removal of the plug connector 724 from the receptacle connector 704. When the button 728 is pressed (e.g., by a user of the HMD), the button 728 can exert a force on the switch structure 730 causing the switch structure 730 to rotate about the pivot point 734. Rotation of the switch structure 730 can cause the switch structure 730 to exert a force on the engagement member 732 which drives or moves the engagement feature 714 out of plug connector 724 to enable removal of the plug connector 724 from the receptacle connector 704. FIGS. 7C-7E represent one particular example of a button module capable of releasably retaining the plug connector within the receptacle connector. Additional, non-limiting, examples of modules capable of releasably retaining the plug connector within the receptacle connector are shown in FIGS. 7F-10B. Any of the features, components, elements, or aspects of any of the modules described with reference to FIGS. 7A-10B can be combined to releasably retain the plug connector within the receptacle connector.

FIG. 7F shows another example of an interlock 706 at least partially receivable within an aperture 740 of the enclosure 702 of the display portion 700. The interlock 706 can include the engagement feature 714, the biasing element 716, and the frame 720. The engagement feature 714 can extend through an aperture 746 formed within the frame 720 and also extend through the aperture 740 to depress an engagement member (e.g., engagement member 322) of a plug connector to interlock the plug connector to the display portion 700. The biasing element 716 can bias the engagement feature 714 to extend through the aperture 740 and into the cavity 712. In some examples, the biasing element 716 can be formed from one or more spring elements wrapped around a rod 742 coupled to the frame 720. The frame 720 can be fastened to the enclosure 702 by one or more fasteners 744A, 744B. Each of the fasteners 744A, 744B can be screws, bolts, rivets, posts, a combination thereof, or any other type of fastener.

FIG. 7G shows another example of an interlock 706 wherein the engagement feature 714 is directly disposed within the aperture 740 (rather than through the frame 720 and aperture 746 as shown in FIG. 7F). In other words, the frame 720 in this example can support the rod 742 and the biasing element 716 yet the engagement feature 714 can be disposed directly within the aperture 740 without contacting the frame 720. For example, distal ends 748A, 748B of the biasing element 716 can be received within correlating recesses 750A, 750B formed on the engagement feature 714 to bias the engagement feature 714 into the aperture 740. The engagement feature 714 can include a protrusion 752 extending laterally from the engagement feature 714 and preventing engagement feature 714 from sliding entirely through the aperture 740.

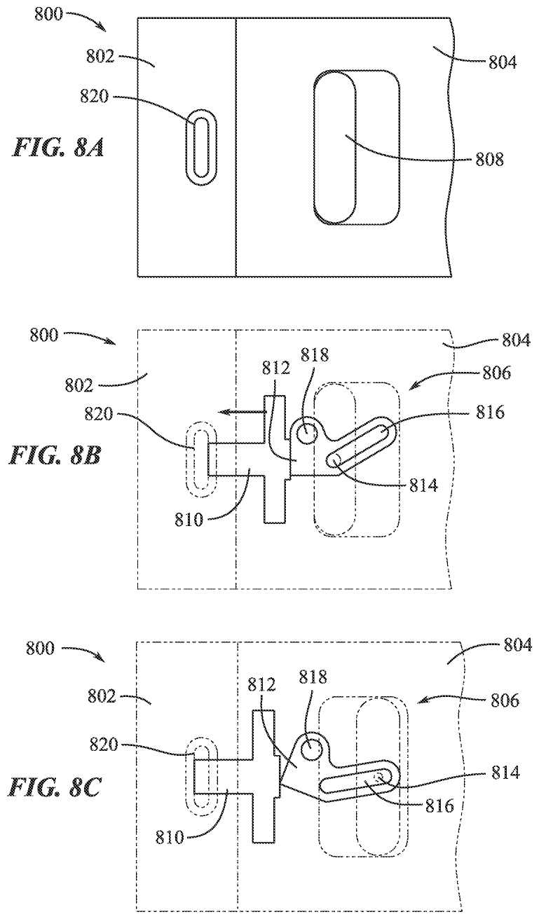

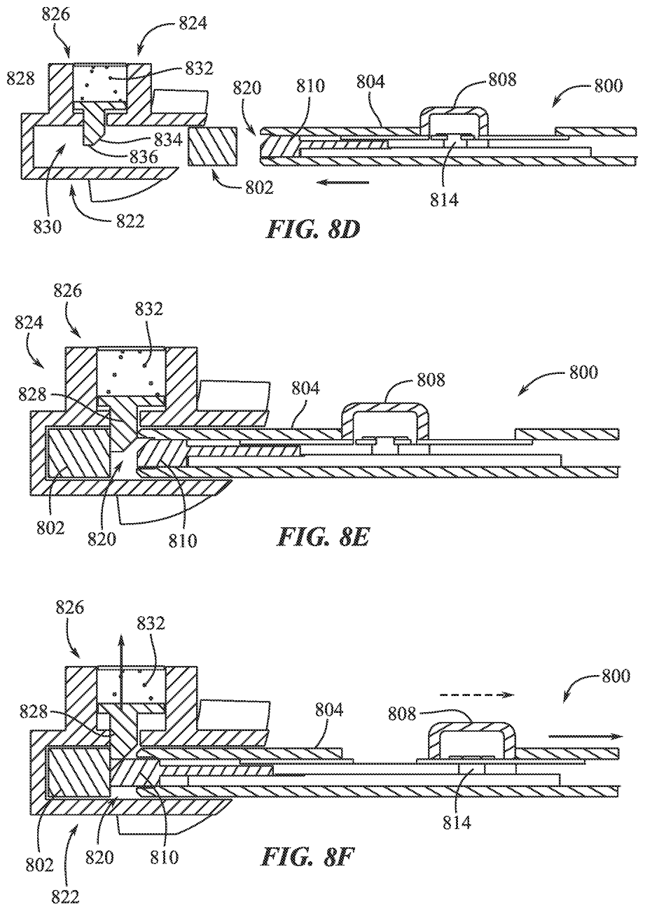

FIGS. 8A-8B show a proximal end of a support 800 including a plug connector 802, an enclosure 804, and a slide module 806. The slide module 806 can include button 808, a sliding member 810, and a rotating member 812. The button 808 can be configured to slide relative to the enclosure 804. For example, as shown on FIG. 8C, the button 808 can slide away from the plug connector 802. The button 808 can include a protrusion 814 disposed within a slot or track 816 of the rotating member 812. When the button 808 is slid (e.g., by a user), the protrusion 814 can cause the rotating member 812 to rotate about a pin 818 and displace the sliding member 810.

In some examples, the plug connector 802 can form an aperture 820. At least a portion of the sliding member 810 can extend into the aperture 820 when the button 808 is slid relative to the enclosure 804. An engagement feature (e.g., engagement feature 714) can be disposed within the aperture 820 while the plug connector 802 is disposed within a receptacle connector (e.g., receptacle connector 704). The slide module 806 can enable the plug connector 802 to be releasably retained within the receptacle connector. For example, at least a portion of the sliding member 810 can contact the engagement feature to drive or move the engagement feature out of the aperture 820 to release the plug connector 802 from the receptacle connector. The functionality of the slide module 806 will be described herein with reference to FIGS. 8D-8F.

FIGS. 8D-8F show example steps of interconnecting and detaching the support 800 and a receptacle connector 822 of a display portion 824. The receptacle connector 822 can be substantially similar to, and can include some or all of, the features of the receptacle connectors 120, 600, 704. For example, the receptacle connector 822 can include an interlock 826 having an engagement feature 828 biased to extend into an internal volume 830 defined by the receptacle connector 822. FIG. 8D shows the support 800 and the receptacle connector 822 prior to insertion of the plug connector 802 within the internal volume 830 of the receptacle connector 822.

FIG. 8E illustrates the plug connector 802 retained within the receptacle connector 822 by the interlock 826 and the slide module 806. In some examples, the engagement feature 828 can be biased (e.g., by a spring 832) to extend into the aperture 820 of the plug connector 802 to interlock the plug connector 802 to the receptacle connector 822 and prevent removal of the plug connector 802 from the receptacle connector 822. In some examples, one or more surfaces 834 of the engagement feature 828 can be obtuse relative to an engagement surface 836 of the engagement feature 828 to ease insertion of the plug connector 802 into the receptacle connector 822.

FIG. 8F illustrates removal of the plug connector 802 from the receptacle connector 822. When the button 808 is slid or moved relative to the enclosure 804 (e.g., by a user of the HMD), the button 808 can cause the rotating member 812 to rotate about the pin 818 (see FIG. 8C). Rotation of the rotating member 812 about the pin 818 can displace a portion of the rotating member 812 to exert a force on the sliding member 810 causing the sliding member 810 to extend, at least partially, into the aperture 820. While sliding or extending into the aperture 820, the sliding member 810 can displace the engagement feature 828 from the aperture 820 to enable removal of the plug connector 802 from the receptacle connector 822.

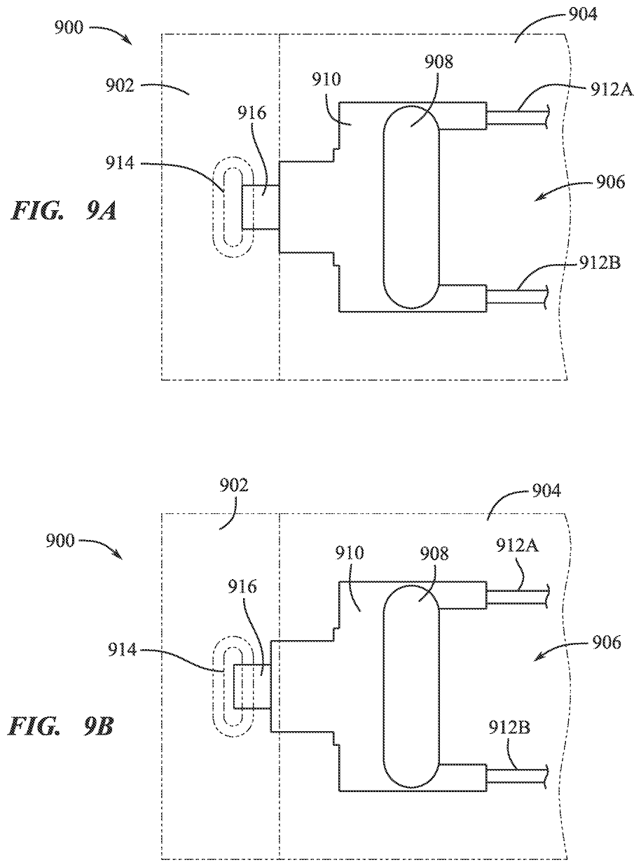

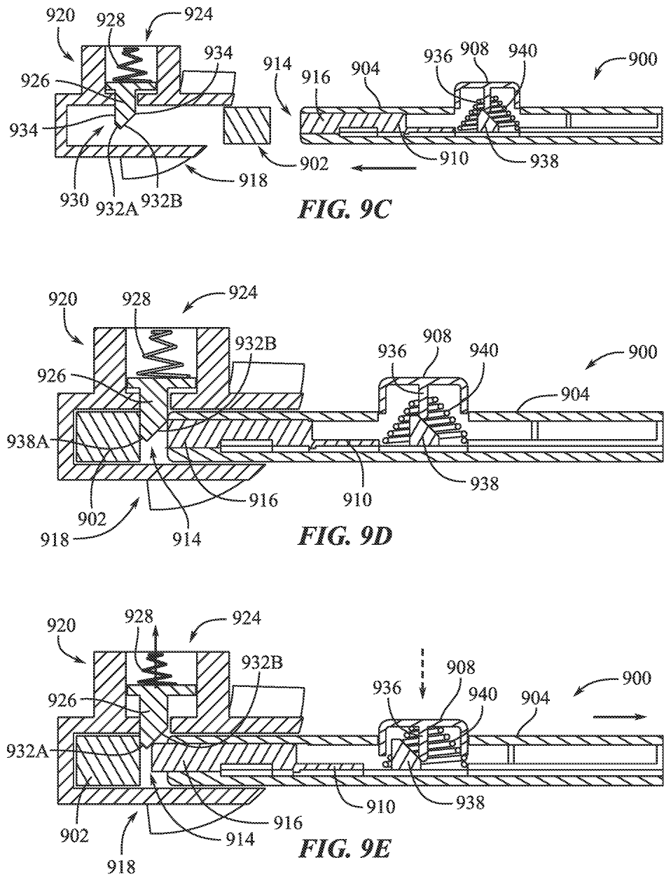

FIGS. 9A-9B show a proximal end of a support 900 including a plug connector 902, an enclosure 904, and a slide module 906. The slide module 906 can include button 908, a sliding member 910, and a rails 912A, 912B. The button 908 can be configured to be pressed or recede into the enclosure 904, for example, the button 908 can be pressed by a user along a first axis. The button 908 can be coupled to the sliding member 910, such that, the sliding member 910 can be slid along the rails 912A, 912B along a second axis when the button 908 is pressed (e.g., by a user). The second axis can be substantially perpendicular to the first axis.

In some examples, the plug connector 902 can form an aperture 914. A distal end 916 of the sliding member 910 can extend into the aperture 914 when the sliding member 910 is slid relative to the enclosure 904 (i.e., along the rails 912A, 912B). An engagement feature (e.g., engagement feature 714) can be disposed within the aperture 914 while the plug connector 902 is disposed within a receptacle connector (e.g., receptacle connector 704). The slide module 906 can enable the plug connector 902 to be releasably retained within the receptacle connector. For example, the distal end 916 of the sliding member 910 can contact the engagement feature to drive or move the engagement feature out of the aperture 914 to release the plug connector 902 from the receptacle connector. The functionality of the slide module 906 will be described herein with reference to FIGS. 9C-9E.

FIGS. 9C-9E show example steps of interconnecting and detaching the support 900 and a receptacle connector 918 of a display portion 920. The receptacle connector 918 can be substantially similar to, and can include some or all of, the features of the receptacle connectors 120, 600, 704. For example, the receptacle connector 918 can include an interlock 924 having an engagement feature 926 biased (e.g., by a spring 928) to extend into an internal volume 930 defined by the receptacle connector 918. FIG. 9C shows the support 900 and the receptacle connector 918 prior to insertion of the plug connector 902 within the internal volume 930 of the receptacle connector 918.

FIG. 9D illustrates the plug connector 902 retained within the receptacle connector 918 by the interlock 924 and the slide module 906. In some examples, the engagement feature 926 can be biased (e.g., by the spring 928) to extend into the aperture 914 of the plug connector 902 to interlock the plug connector 902 to the receptacle connector 918 and prevent removal of the plug connector 902 from the receptacle connector 918. In some examples, one or more surfaces 932A, 932B of the engagement feature 926 can form obtuse angles relative to a side surface 934 of the engagement feature 926 to ease insertion/removal of the plug connector 902 into/from the receptacle connector 918.

FIG. 9E illustrates removal of the plug connector 902 from the receptacle connector 918. When the button 908 is pressed, a portion 936 of the button 908 can contact a raised portion 938 of the sliding member 910, such that, the sliding member 910 slides or moves relative to the enclosure 904. For example, the portion 936 of the button 908 can contact an angled surface 942 of the raised portion 938 and vertical translation of the button 908 can cause horizontal translation of the sliding member 910. In some examples, the button 908 can be biased (e.g., by a spring 940) to depress or rebound away from the raised portion 938. Translation of the sliding member 910 along the rails 912A, 912B can displace the distal end 916 of the sliding member 910, at least partially, into the aperture 914. While sliding or extending into the aperture 914, the distal end 916 can displace the engagement feature 926 from the aperture 914 to enable removal of the plug connector 902 from the receptacle connector 918.

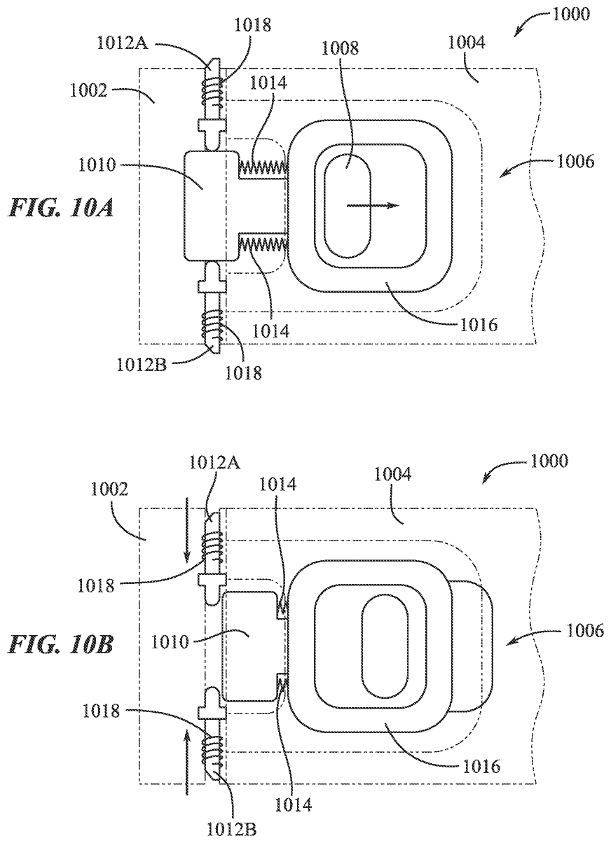

FIGS. 10A and 10B show a proximal end of a support 1000 including a plug connector 1002, an enclosure 1004, and a slide module 1006. The slide module 1006 can include button 1008 affixed to a sliding member 1010, and one or more pins 1012A, 1012B. The button 1008 and the sliding member 1010 can be configured to slide relative to the enclosure 1004. For example, the button 1008 and sliding member 1010 can slide away from or toward the proximal end of the support 1000. While the sliding member 1010 is disposed between the pins 1012A, 1012B (see FIG. 10A), each of the pins 1012A, 1012B can extend from the plug connector 1002. In some examples, a receptacle connector (e.g., receptacle connector 704) can include apertures which receive the portions of the pins 1012A, 1012B extending from the plug connector 1002 to interlock the support 1000 to the receptacle connector. When the button 1008 is slid (e.g., by a user), the sliding member 1010 can be displaced, such that, a portion of the sliding member 1010 is not disposed between the pins 1012A, 1012B causing the pins to move toward one another (see FIG. 10B). While the sliding member 1010 is not disposed between the pins 1012A, 1012B, the pins 1012A, 1012B can be wholly disposed within the plug connector 1002 and enable extraction of the plug connector 1002 from the receptacle connector.

In some examples, the sliding member 1010 can be biased toward the plug connector 1002 (i.e., biased to be positioned between the pins 1012A, 1012B). For example, one or more springs 1014 can be disposed between the sliding member 1010 and a button housing 1016 or other component of the support 1000. In some examples, one or more of the pins 1012A, 1012B can be biased (e.g., by a spring 1018) to be wholly disposed within the plug connector 1002 (i.e., each pin 1012A, 1012B can be biased toward the other pin). In other examples, one or more of the pins 1012A, 1012B can be biased to extend from the plug connector 1002 (i.e., each pin 1012A, 1012B can be biased away from the other pin).

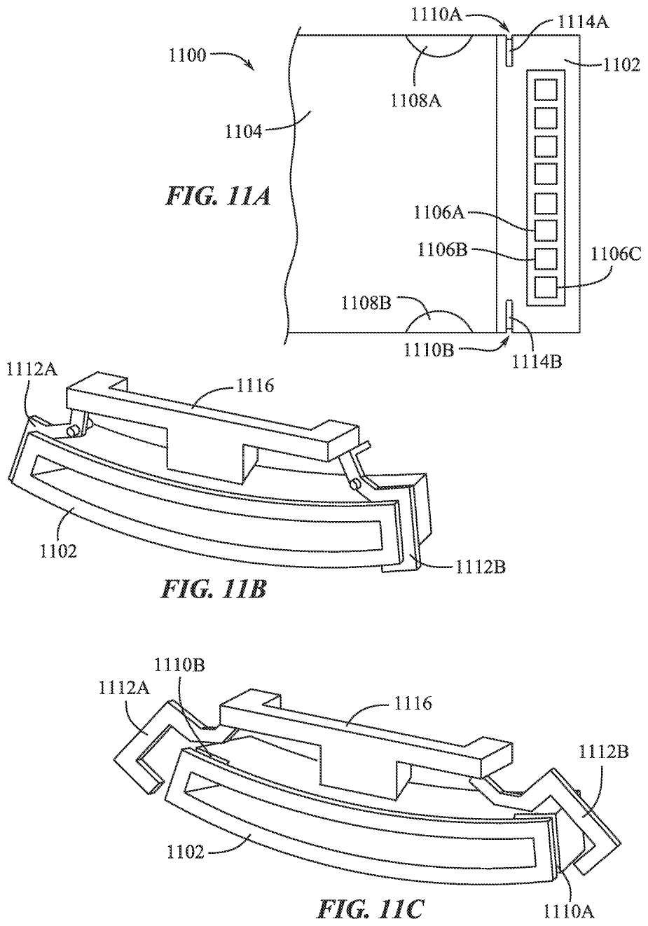

Any number or variety of components in any of the configurations described herein can be included in the electronic device (e.g., HMD). The components can include any combination of the features described herein and can be arranged in any of the various configurations described herein. The structure and arrangement of components of an electronic device having a support and a display portion with structures described herein as well as the concepts regarding various sub-components, can apply not only to the specific examples discussed herein, but to any number of examples in any combination. Examples of receptacle connections for a display portion of an HMD and plug connectors of a support for the HMD are described below, with reference to FIGS. 11A-11C.

FIG. 11A shows a proximal end of a support 1100, including a plug connector 1102, an enclosure 1104, one or more electrical contacts (e.g., electrical contacts 1106A, 1106B, 1106C), and one or more buttons 1108A, 1108B. In some examples, the plug connector 1102 can form one or more slots 1110A, 1110B. Each slot 1110A, 1110B can be configured to receive at least a portion of a respective clip 1112A, 1112B (see FIGS. 11B and 11C) to retain the support 1100 within a receptacle connector (e.g., receptacle connector 704). For example, as shown in FIGS. 11B and 11C, each of the one or more clips 1112A, 1112B can articulate relative to a clip mount 1116 to move within a respective slot 1110A, 1110B. When the buttons 1108A, 1108B are squeezed together or otherwise pressed, a movable member 1114A, 1114B within each slot 1110A, 1110B can move or translate within the slot to force the clip 1112A, 1112B out of engagement with the slot 1110A, 1110B. In other words, the one or more buttons 1108A, 1108B can be squeezed are pressed to displace the clips 1112A, 1112B out of the slots 1110A, 1110B and enable removal of the plug connector 1102 from the receptacle connector.

Personal information data, gathered pursuant to authorized and well established secure privacy policies and practices that are appropriate for the type of data collected, can be incorporated by the present systems and methods to implement and improve on the various embodiments described herein. The disclosed technology is not, however, rendered inoperable in the absence of such personal information data.

It will be understood that the details of the present systems and methods detailed above can be combined in various combinations and with alternative components not specifically disclosed herein. The scope of the present systems and methods will be further understood by the following claims.

What is claimed is:

1. A head mountable display (HMD), comprising:
a housing;
a display connected to the housing; and
a receptacle connector disposed in the housing, the receptacle connector comprising:
a receptacle housing defining an aperture and an internal volume, the receptacle housing configured to receive a portion of a support of the HMD within the internal volume;
an electrical contact at least partially disposed within the internal volume, the electrical contact configured to electrically couple the receptacle connector and the support;
an engagement feature disposed within an aperture formed within a side wall of the receptacle housing, the engagement feature extending into the internal volume from the side wall, the engagement feature being movable relative to the side wall; and
a mount connected to the receptacle housing;
wherein the engagement feature is pivotably attached to the mount.

2. The HMD of claim 1, wherein the aperture defines a cross-sectional shape having a curving longitudinal axis.

3. The HMD of claim 1, further comprising a datum rail disposed on a side wall of the receptacle housing, the datum rail extending into the internal volume.

4. The HMD of claim 1, further comprising a spring biasing the engagement feature into the internal volume;
wherein the engagement feature is configured to interlock with the portion of the support.

5. The HMD of claim 1, wherein:
the receptacle housing comprises an electrically insulating material;
the electrical contact is disposed within a side wall of the receptacle housing; and
the receptacle connector further comprises a cover.

6. The HMD of claim 5, wherein the receptacle connector further comprises an adhesive layer disposed between the receptacle housing and the cover, the adhesive layer electrically isolating the set of electrical contacts from the cover.

7. The HMD of claim 1, wherein:
the electrical contact is a first electrical contact of a first set of electrical contacts and the receptacle connector further comprises a second set of electrical contacts at least partially disposed within the internal volume;
the first set of electrical contacts are disposed on a first side of the internal volume; and
the second set of electrical contacts are disposed on a second side of the internal volume.

8. A plug connector for engaging with a head mountable display, comprising:
a body including a convex surface defining a first surface of the body, a concave surface defining a second surface of the body opposite the first surface, a third surface of the body extending between the first surface and the second surface, and a fourth surface extending between the first surface and the second surface opposite the third surface;
an electrical contact disposed on the concave surface or the convex surface;
a polymer disposed over the body around the electrical contact;
a side engagement slot defined by the third surface extending from the first surface to the second surface;
a printed circuit board electrically coupled to the electrical contact; and
a processor disposed on the printed circuit board.

9. The plug connector of claim 8, wherein the body forms a channel defined by the third surface.

10. The plug connector of claim 8, further comprising a button, comprising:
a switch housing;
a switch structure at least partially disposed within the switch housing;
a button coupled to the switch structure; and
an engagement member coupled to the switch structure and configured to translate relative to the switch housing.

11. The plug connector of claim 8, wherein the printed circuit board defines a cutout and the button is at least partially disposed within the cutout.

12. The plug connector of claim 8, wherein:
the electrical contact is a first electrical contact disposed on the concave surface; and
the plug connector further comprises a second electrical contact disposed on the convex surface.

13. The plug connector of claim 8, wherein:
the body comprises a metal portion;
the convex surface is at least partially defined by a polymer coupled to the metal portion;
the concave surface is at least partially defined by the polymer coupled to the metal portion; and
the electrical contact is at least partially disposed within the polymer.

14. The plug connector of claim 8, further comprising a button, comprising:
a rotating member defining a slot;
a button defining a protrusion at least partially disposed within the slot, translation of the button causing the rotating member to rotate about an axis; and
a sliding member, rotation of the rotating member displacing the sliding member from a first location to a second location.

15. The plug connector of claim 8, further comprising a button, comprising:
a sliding member; and
a button contacting the sliding member;
wherein pressing the button causes the sliding member to translate relative to the button, the button translating along a first axis, the sliding member translating along a second axis substantially perpendicular to the first axis.

16. A support for a head-mounted display (HMD), comprising:
an enclosure having a proximal end; and
a plug connector attached to the proximal end and configured to be electrically coupled to a display portion of the HMD, the plug connector comprising:
a body;
an electrical contact coupled to the body;
a printed circuit board electrically coupled to the electrical contact; and
a speaker disposed in the enclosure and connected to the printed circuit board.

17. The support of claim 16, wherein the enclosure defines a cross-sectional shape having a curving longitudinal axis.

18. The support of claim 16, wherein the plug connector further comprises an electrical wire coupled to the printed circuit board and extending within the enclosure toward the distal end.

19. The support of claim 16, wherein the electrical contact is one of multiple electrical contacts disposed on two or more surfaces defined by the body.

20. The support of claim 16, further comprising a receptacle connector electrically coupled to the plug connector, the receptacle connector disposed on the enclosure between the proximal end and the distal end.
